(19) United States
(12) Patent Application Publication
(10) Pub. No.: US 2021/0324609 A1
(43) Pub. Date: Oct. 21, 2021

(54) Hydraulic Drive System for Construction Machine

(71) Applicant: Hitachi Construction Machinery Tierra Co., Ltd., Koka-shi, Shiga (JP)

(72) Inventors: Kiwamu TAKAHASHI, Moriyama-shi (JP); Taihei MAEHARA, Koka-shi (JP); Takeshi ISHII, Gamou-gun, Hino-cho (JP)

(21) Appl. No.: 16/492,409

(22) PCT Filed: Mar. 28, 2018
(86) PCT No.: PCT/JP2018/013015

§ 371 Date: Sep. 9, 2019

(51) Int. Cl. E02F 9/22; E02F 9/20; F15B 15/20

(52) U.S. Cl. CPC E02F 9/2228; E02F 9/2235; E02F 9/2296; E02F 3/964; E02F 9/2267; E02F 9/2004; F15B 15/202; E02F 9/2271

(57) ABSTRACT

Even where the differential pressure across a directional control valve associated with each actuator is very small, flow dividing control of the plurality of directional control valves can be performed stable, and even where a demanded flow rate suddenly changes at the time of transition from composite action to single action or the like, a sudden change of the flow rate of hydraulic fluid to be supplied to each actuator is prevented to implement superior combined operability. Further, the meter-in loss of the directional control valves can be reduced to implement a high energy efficiency. To this end, a plurality of pressure compensating valves 7a, 7b and 7c for controlling such that the pressure in the downstream side of the meter-in opening of a plurality of directional control valves 6a, 6b and 6c becomes equal to the highest load pressure are individually arranged in the downstream side of meter-in openings of the plurality of directional control valves 6a, 6b and 6c, and demanded flow rates for the directional control valves 6a, 6b and 6c are calculated from input amounts of operation levers. Besides, the meter-in pressure loss of a predetermined directional control valve is calculated from the demanded flow rates for and meter-in opening areas of the directional control valves 6a, 6b and 6c, and the set pressure of the unloading valve 15 is controlled using the value of the meter-in pressure loss.

### TECHNICAL FIELD

The present invention relates to a hydraulic drive system for a construction machine such as a hydraulic excavator that performs various works, and particularly to a hydraulic drive system for a construction machine that supplies hydraulic fluid delivered from one or more hydraulic pumps to a plurality of two or more actuators through two or more of a plurality of control valves to perform driving.

### BACKGROUND ART

As a hydraulic drive system for a construction machine such as a hydraulic excavator, as disclosed, for example, in Patent Document 1, load sensing control for controlling the displacement of a hydraulic pump is widely utilized such that the differential pressure between the delivery pressure of a variable displacement hydraulic pump and the highest load pressure of a plurality of actuators is kept to a set value.

In Patent Document 2, a hydraulic drive system is disclosed which includes a variable displacement hydraulic pump, a plurality of actuators, a plurality of meter-in orifices that control the flow rate of hydraulic fluid to be supplied from the hydraulic pump to the plurality of actuators, a plurality of pressure compensating valves provided in the downstream of the plurality of meter-in orifices and a controller that controls the delivery flow rate of the hydraulic pump in response to a lever input of an operation lever device and adjusts the plurality of meter-in orifices in response to the lever input, in which the controller controls to fully open the meter-in orifice associated with the actuator having the highest load pressure on the basis of the lever input. In the hydraulic drive system, the plurality of pressure compensating valves provided in the downstream of the plurality of meter-in orifices control such that the pressure in the downstream side of the meter-in orifices becomes equal to the highest load pressure without using a differential pressure or LS differential pressure between the pump pressure and the highest load pressure.

In Patent Document 3, a drive system is proposed which includes a variable displacement hydraulic pump, a plurality of actuators, a plurality of adjustment valves that have a throttle action at individual intermediate positions thereof and supply hydraulic fluid delivered from the hydraulic pump to the plurality of actuators, an unloading valve provided on a hydraulic fluid supply line of the hydraulic pressure, a controller that controls the delivery flow rate of the hydraulic pump in response to a lever input of an operation lever device, and a pressure sensor that detects the delivery pressure of the hydraulic pump and the load pressure of at least one of the actuators, in which the controller controls the opening of an adjustment valve having a throttle action at an intermediate position thereof in response to the differential pressure between the delivery pressure of the hydraulic pump and the actuator load pressure detected by the pressure sensor. In the drive system, the set pressure of the unloading valve is set depending upon the highest load pressure of the actuators introduced in a closing direction of the unloading valve and a spring provided in the same direction, and the delivery pressure of the hydraulic pump is controlled so as not to exceed a value of the sum of the highest load pressure and the spring force.

### PRIOR ART DOCUMENT

### Patent Documents

Patent Document 1: JP-2015-105675-A
Patent Document 2: JP-2007-506921-T
Patent Document 3: JP-2014-98487-A

### SUMMARY OF THE INVENTION

### Problems to be Solved by the Invention

In such conventional load sensing control as disclosed in Patent Document 1, although a differential pressure called LS differential pressure between a delivery pressure or pump pressure of a hydraulic pump and a differential pressure of the highest load pressure, which is caused by a differential pressure across a meter-in opening of each main spool or flow rate control valve, is used for pump flow rate control and flow dividing control of the main spool by a pressure compensating valve, the LS differential pressure is meter-in loss itself and makes one factor that hinders high energy efficiency of the hydraulic system.

Although, in order to increase the energy efficiency of the hydraulic system, it is sufficient if the meter-in final opening of each main spool, namely, the meter-in opening area in full stroke of the main spool, is increased extremely to reduce the LS differential pressure, in current load sensing control, the LS differential pressure cannot be reduced extremely to zero or the like. The reason is such as described below.

The pressure compensating valve that performs flow dividing control of each main spool controls the opening of the main spool such that the differential pressure across the main spool becomes equal to the LS differential pressure. In the case where the meter-in final opening of the main spool is extremely great and the LS differential pressure becomes zero as described above, each pressure compensating valve adjusts the opening of the individual main spool such that the differential pressure across the main spool becomes zero. However, in this case, there is a problem that, since the target differential pressure for determining the opening of the pressure compensating valve becomes zero, the opening of the pressure compensating valve, namely, the position of the spool in the case where the pressure compensating valve is of the spool valve type but the lift amount of the poppet valve in the case where the pressure compensating valve is of the poppet valve type, is not determined uniquely and the pressure control of the pressure compensating valve becomes unstable, which causes hunting.

According to the structure of Patent Document 2, since the meter-in opening of the actuator having the highest load pressure is fully opening controlled, the LS differential pressure that is one of factors that obstruct increase of high energy efficiency in the conventional load sensing control can be eliminated and a hydraulic system in which the energy efficiency is high can be implemented.

Here, as the pressure compensating valve, two pressure compensating valves are available including a pressure compensating valve in which the differential pressure across the meter-in opening of each main spool is controlled so as to become equal to a fixed value determined in advance or to a differential pressure or LS differential pressure between the pump pressure and the highest load pressure and another pressure compensating valve that is arranged in the downstream side of the meter-in opening of each main spool and in which the pressure in the downstream side of the meter-in opening is controlled so as to become equal to the highest load pressure of the plurality of actuators without using the LS differential pressure. The former pressure compensating valve is generally called load sensing valve, and the pressure compensating valve disclosed in Patent Document 1 is applicable to this type. The latter pressure compensating valve is called flow sharing valve, and the pressure compensating valve disclosed in Patent Document 2 is applicable to this type. In any case, the pressure compensating value is combined with the load sensing control of the hydraulic pump and is called load sensing system as a whole.

In Patent Document 2, since the flow sharing valve in which the LS differential pressure is not used is used as the pressure compensating valve, the problem that control of the pressure compensating valve becomes unstable does not occur as in the case in which the LS differential pressure is reduced to zero in the load sensing control in which the load sensing valve is used as the pressure compensating valve as in Patent Document 1.

However, also the conventional technology disclosed in Patent Document 2 has such a problem as described below.

In particular, since a throttle orifice, namely, a meter-in opening, associated with the highest load pressure actuator is usually controlled to full opening, there is a case in which, for example, in such a case that, from a state in which an actuator having the highest load pressure and another actuator having a low load pressure are operated at the same time, operation of the actuator whose load pressure is lower is stopped suddenly, certain fixed time is required for decrease of the flow rate to be delivered from the limit of responsiveness in flow rate control of the hydraulic pump.

In such a case as just described, since the throttle orifice of the actuator having the highest load pressure is controlled to maximum opening, hydraulic fluid delivered from the hydraulic pump flows into the highest load pressure actuator without being throttled by the opening of the throttle orifice. Therefore, the speed of the highest load pressure actuator sometimes increases suddenly.

In the case where the operation lever of the highest load pressure actuator is in a full operation state and the working speed of the actuator is originally so high that a great flow amount is supplied, the influence on the behavior of the work machine is comparatively small. However, since, in the case where the operation lever of the highest load pressure actuator is in a half operated state, the original flow rate is low and the influence when the flow rate supplied to the actuator increases suddenly as described above cannot be ignored. Therefore, there is a case that an unpleasant shock is given to an operator of the work machine.

According to the structure of Patent Document 3, since hydraulic fluid supplied from the hydraulic pump in response to each lever input can be divided only by a plurality of adjustment valves without using the pressure compensating valve, the cost of the hydraulic system can be reduced.

Further, in Patent Document 3, since the opening of the plurality of adjustment valves is calculated and determined in an electronic controller from the target flow rate to each actuator set in response to an operation lever and the differential pressure between the pump pressure and the highest load pressure detected by the pressure sensor, such a problem that control of the pressure compensating valve becomes unstable as in the case in which the LS differential pressure is set to zero by conventional load sensing control does not occur.

However, the conventional technology disclosed in Patent Document 3 has such a problem as described below.

In particular, while an unloading valve is provided on a hydraulic fluid supply line from the hydraulic pump, the set pressure of the unloading valve is set by the highest load pressure and spring force.

On the other hand, since openings, namely, meter-in openings, of the plurality of adjustment valves depend upon the differential pressure between the pump pressure and the actuator load pressure and the target flow rate of each actuator set in response to each operation lever, the pump pressure sometimes increases by an amount corresponding to the pressure loss in the adjustment valve associated with the highest load pressure actuator with respect to the highest load pressure.

However, since the set pressure of the unloading valve is set only by the highest load pressure and the spring force as described above, for example, in the case where the pressure loss at the adjustment valve associated with the highest load pressure actuator is high as described above, there is a case in which the pump pressure exceeds the pressure set based on the highest load pressure and the spring force and the unloading valve is placed into an opening position, at which hydraulic fluid supplied from the hydraulic pump is discharged to the tank. Since the hydraulic fluid discharged by the unloading valve is useless bleed-off loss, the energy efficiency of the hydraulic system is sometimes lost.

On the other hand, it is possible to increase the spring force, namely, to increase the set pressure high, of the unloading valve so as to prevent such a situation that the pressure loss by the adjustment valve associated with the highest load pressure actuator becomes so high as to exceed the set pressure of the unloading valve to cause useless bleed-off loss. However, in this case, for example, in the case where, from a state in which two or more actuators are being operated at the same time, only the lever operation of one of the actuators is stopped suddenly, sudden increase of the pump pressure arising from a situation in which the flow rate reduction control of the hydraulic pump is not performed in time cannot be suppressed by the unloading valve. Therefore, similarly as in the case where Patent document 2 is used, an unpleasant shock to an operator sometimes occur.

It is an object of the present invention to provide a hydraulic drive system for a construction machine that includes a variable displacement hydraulic pump and supplies hydraulic fluid delivered by the hydraulic pump to a plurality of actuators through a plurality of control valves to drive the plurality of actuators, in which (1) even in the case where the differential pressure across a directional control valve associated with each actuator is very small, flow dividing control of the plurality of directional control valves can be performed in a stable state, (2) even in the case where a demanded flow rate suddenly changes at the time of transition from composite action to single action or the like, the bleed-off loss that hydraulic fluid is discharged uselessly from an unloading valve to a tank is suppressed to suppress decrease of the energy efficiency and besides sudden change of the actuator speed by a sudden change of the flow rate of the hydraulic fluid to be supplied to the actuator is prevented to suppress occurrence of an unpleasant shock thereby to implement superior combined operability, and (3) the meter-in loss of the directional control valve can be reduced to implement a high energy efficiency.

### Means for Solving the Problems

In order to attain the object described above, according to the present invention, there is provided a hydraulic drive system for a construction machine, comprising: a variable displacement hydraulic pump; a plurality of actuators driven by hydraulic fluid delivered from the hydraulic pump; a control valve device that distributes and supplies the hydraulic fluid delivered from the hydraulic pump to the plurality of actuators; a plurality of operation lever devices that instruct driving directions and speeds of the plurality of actuators; a pump regulation device that controls a delivery flow rate of the hydraulic pump so as to deliver a flow rate according to input amounts of operation levers of the plurality of operation lever devices; an unloading valve that discharges the hydraulic fluid of a hydraulic fluid supply line of the hydraulic pump to a tank when a pressure of the hydraulic fluid supply line increases and exceeds a set pressure equal to a sum of a highest load pressure of the plurality of actuators and at least a target differential pressure; and a controller that controls the control valve device, wherein the control valve device includes: a plurality of directional control valves that are individually shifted by the plurality of operation lever devices and associated with the plurality of actuators to adjust driving directions and speeds of the respective actuators, and a plurality of pressure compensating valves arranged in downstream sides of the plurality of directional control valves for controlling pressures in downstream sides of meter-in openings of the plurality of directional control valves such that the pressures in downstream sides of meter-in openings of the plurality of directional control valves becomes equal to the highest load pressure, and the controller is configured to: calculate demanded flow rates for the plurality of actuators and meter-in opening areas of the plurality of directional control valves based on input amounts of the operation levers of the plurality of operation lever devices, calculate a meter-in pressure loss of a particular directional control valve among the plurality of directional control valves based on the meter-in opening areas and the demanded flow rates, and output the pressure loss as the target differential pressure to control the set pressure of the unloading valve.

Since the present invention is configured such that flow dividing control of the plurality of directional control valves is performed by using the plurality of pressure compensating values (flow sharing valves) arranged in downstream sides of the plurality of directional control valves for controlling pressures in downstream sides of meter-in openings of the plurality of directional control valves such that the pressures in the downstream sides of the meter-in openings of the plurality of directional control valves becomes equal to the highest load pressure, even in the case where the differential pressures, namely, the meter-in pressure losses, across the directional control valves associated with the individual actuators are very small, flow dividing control of the plurality of directional control valves can be performed stably.

Further, in the present invention, the controller is configured to calculate demanded flow rates for the plurality of actuators and meter-in opening areas of the plurality of directional control valves based on input amounts of the operation levers of the plurality of operation lever devices, calculate a meter-in pressure loss of a particular directional control valve among the plurality of directional control valves based on the meter-in opening areas and the demanded flow rates, and output the pressure loss as the target differential pressure to control the set pressure of the unloading valve.

Consequently, since the set pressure of the unloading valve is controlled to the value of the sum of the highest load pressure and at least the target differential pressure, which is equivalent to the meter-in pressure loss, in such a case that the meter-in opening of a directional control valve is throttled by a half operation of the operation lever of the particular directional control valve or a like operation, the set pressure of the unloading valve is controlled carefully in response to the pressure loss at the meter-in opening of the directional control valve. As a result, even in the case where the demanded flow rate changes suddenly at the time of transition from a combined action to a single operation or the like and the pump pressure increases suddenly due to insufficient responsiveness of pump flow rate control, bleed-off loss in which hydraulic fluid is discharged uselessly from the unloading valve to the tank can be suppressed to the minimum and reduction of the energy efficiency can be suppressed and besides a sudden change of the actuator speed by a sudden change of the flow rate of the supplied hydraulic fluid can be prevented to suppress occurrence of an unpleasant shock thereby implement superior combined operability.

Further, in the present invention, even in the case where the differential pressure across each of the directional control valves is very small as described above, flow dividing control of the plurality of directional control valves can be performed stably. Besides, since the set pressure of the unloading valve can be controlled carefully in response to the pressure loss at the meter-in opening of the directional control valve, it becomes possible to make the final meter-in opening of each of the directional control valves, namely, the meter-in opening area at a full stroke of the main spool, extremely great. Consequently, it is possible to reduce the meter-in loss and implement a high energy efficiency.

### Advantages of the Invention

According to the present invention, the hydraulic drive system for a construction machine that includes a variable displacement hydraulic pump and supplies hydraulic fluid delivered by the hydraulic pump to a plurality of actuators through a plurality of control valves to drive the plurality of actuators

(1) can perform flow dividing control of the plurality of directional control valves stably even in the case where the differential pressure across a directional control valve associated with each actuator is very small;

(2) can suppress, even in the case where a demanded flow rate suddenly changes at the time of transition from composite action to single action or the like and pump pressure increases suddenly due to insufficient responsiveness of pump flow rate control, the bleed-off loss that hydraulic fluid is discharged uselessly from the unloading valve to the tank is suppressed to the minimum to suppress decrease of the energy efficiency and besides sudden change of the actuator speed by a sudden change of the flow rate of the hydraulic fluid to be supplied to each actuator is prevented to suppress occurrence of an unpleasant shock thereby to implement superior combined operability, and

(3) can reduce the meter-in loss of the directional control valve to implement a high energy efficiency.

### BRIEF DESCRIPTION OF THE DRAWINGS

FIG. 1 is a view depicting a structure of a hydraulic drive system for a construction machine according to a first embodiment of the present invention.

FIG. 2 is an enlarged view of peripheral elements of an unloading valve in the hydraulic drive system of the first embodiment.

FIG. 3 is an enlarged view of peripheral elements of a main pump including a regulator in the hydraulic drive system of the first embodiment.

FIG. 4 is a view depicting an appearance of a hydraulic excavator that is a representative example of a construction machine in which the hydraulic drive system of the present invention is incorporated.

FIG. 5 is a functional block diagram of a controller in the hydraulic drive system of the first embodiment.

FIG. 6 is a functional block diagram of a main pump actual flow rate calculation section in the controller.

FIG. 7 is a functional block diagram of a demanded flow rate calculation section in the controller.

FIG. 8 is a functional block diagram of a demanded flow rate correction section in the controller.

FIG. 9 is a functional block diagram of a meter-in opening calculation section in the controller.

FIG. 10 is a functional block diagram of a target differential pressure calculation section in the controller.

FIG. 11 is a functional block diagram of a main pump target tilting angle calculation section in the controller.

FIG. 12 is a view depicting a structure of a hydraulic drive system for a construction machine according to a second embodiment of the present invention.

FIG. 13 is a functional block diagram of a controller in the hydraulic drive system of the second embodiment.

FIG. 14 is a functional block diagram of a highest load pressure actuator decision section in the controller.

FIG. 15 is a functional block diagram of a directional control valve meter-in opening calculation section of a highest load pressure actuator in the controller.

FIG. 16 is a functional block diagram of a corrected demanded flow rate calculation section of the highest load pressure actuator in the controller.

FIG. 17 is a functional block diagram of a target differential pressure calculation section in the controller.

FIG. 18 is a view depicting a structure of a hydraulic drive system for a construction machine according to a third embodiment of the present invention.

FIG. 19 is a functional block diagram of a controller in the hydraulic drive system of the third embodiment.

FIG. 20 is a functional block diagram of a demanded flow rate calculation section in the controller.

FIG. 21 is a functional block diagram of a main pump target tilting angle calculation section in the controller.

### MODES FOR CARRYING OUT THE INVENTION

In the following, embodiments of the present invention are described with reference to the drawings.

### First Embodiment

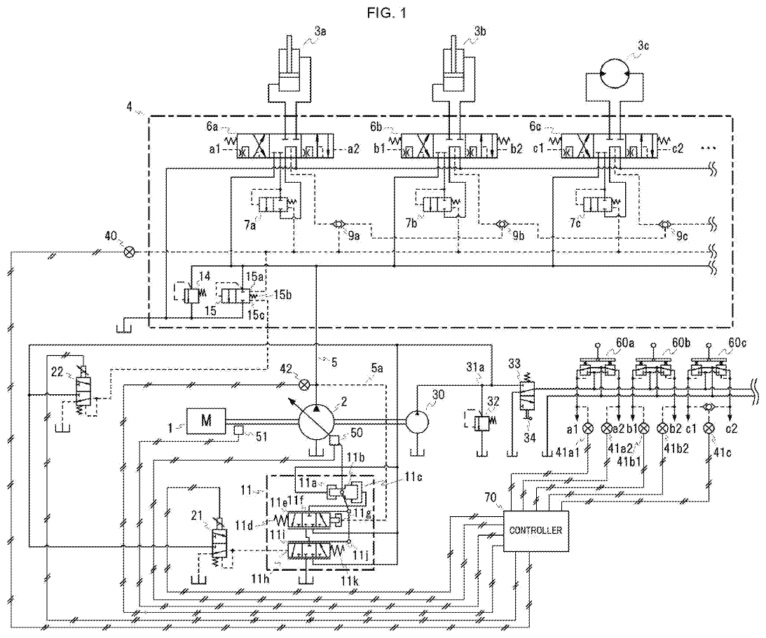

A hydraulic drive system for a construction machine according to a first embodiment of the present invention is described with reference to FIGS. 1 to 15.

˜Structure˜

FIG. 1 is a view depicting a structure of the hydraulic drive system for a construction machine according to the first embodiment of the present invention.

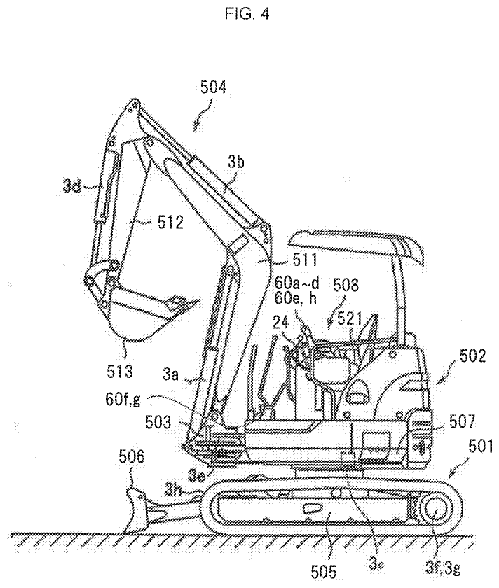

Referring to FIG. 1, the hydraulic drive system of the present embodiment includes a prime mover 1, a main pump 2 in the form of a variable displacement hydraulic pump driven by the prime mover 1, a pilot pump 30 of the fixed displacement type, a plurality of actuators driven by hydraulic fluid delivered from the main pump 2, a hydraulic fluid supply line 5, and a control valve block 4. The plurality of actuators include a boom cylinder 3a, an arm cylinder 3b, a swing motor 3c, a bucket cylinder 3d depicted in FIG. 4, a swing cylinder 3e depicted in FIG. 4, travelling motors 3f and 3g depicted in FIG. 4, and a blade cylinder 3h depicted in FIG. 4. The hydraulic fluid supply line 5 introduces hydraulic fluid delivered from the main pump 2 to the plurality of actuators 3a, 3b, 3c, 3d, 3e, 3f, 3g and 3h. The control valve block 4 is connected to the downstream of the hydraulic fluid supply line 5 such that hydraulic fluid delivered from the main pump 2 is introduced to the control valve block 4. In the following description, the “actuators, 3a, 3b, 3c, 3d, 3e, 3f, 3g and 3h” are represented in an abbreviated formed as “actuators 3a, 3b, 3c, . . . .”

In the control valve block 4, a plurality of directional control valves 6a, 6b, 6c, . . . for controlling the plurality of actuators 3a, 3b, 3c, . . . and a plurality of pressure compensating valves 7a, 7b, 7c, . . . positioned in the downstream side of the meter-in opening of the plurality of directional control valves 6a, 6b, 6c, . . . , respectively, are arranged. Each of the pressure compensating valves 7a, 7b, 7c, . . . has provided herein a spring for biasing the spool thereof in its closing direction. Besides, the pressure in the downstream side of the meter-in opening of the plurality of directional control valves 6a, 6b, 6c, . . . is introduced to the side to which the spools of the pressure compensating valves 7a, 7b, 7c, . . . are biased in the opening direction, and the highest load pressure Plmax of the plurality of actuators 3a, 3b, 3c, . . . hereinafter described is introduced to the side to which the spool of the pressure compensating valves 7a, 7b, 7c, . . . is biased to the closing direction.

The plurality of directional control valves 6a, 6b, 6c, . . . and the plurality of pressure compensating valves 7a, 7b, 7c, . . . configure a control valve device that distributes and supplies hydraulic fluid delivered from the main pump 2 to the plurality of actuators 3a, 3b, 3c, . . . .

Further, in the control valve block 4, in the downstream of the hydraulic fluid supply line 5, a relief valve 14 that discharges hydraulic fluid of the hydraulic fluid supply line 5 to a tank if the pressure in the hydraulic fluid supply line 5 becomes equal to or higher than a set pressure determined in advance and an unloading valve 15 that discharges hydraulic fluid in the hydraulic fluid supply line 5 to the tank if pressure in the hydraulic fluid supply line 5 becomes equal to or higher than a certain set pressure are provided.

Further, in the control valve block 4, shuttle valves 9a, 9b, 9c, . . . connected to the load pressure detection port of the plurality of directional control valves 6a, 6b, 6c, . . . are arranged. The shuttle valves 9a, 9b, 9c, . . . are provided for detecting the highest load pressure of the plurality of actuators 3a, 3b, 3c, . . . and configures a highest load pressure detection device. The shuttle valves 9a, 9b, 9c, . . . are connected in a tournament fashion, and the highest load pressure is detected at the shuttle valve 9a of the top level.

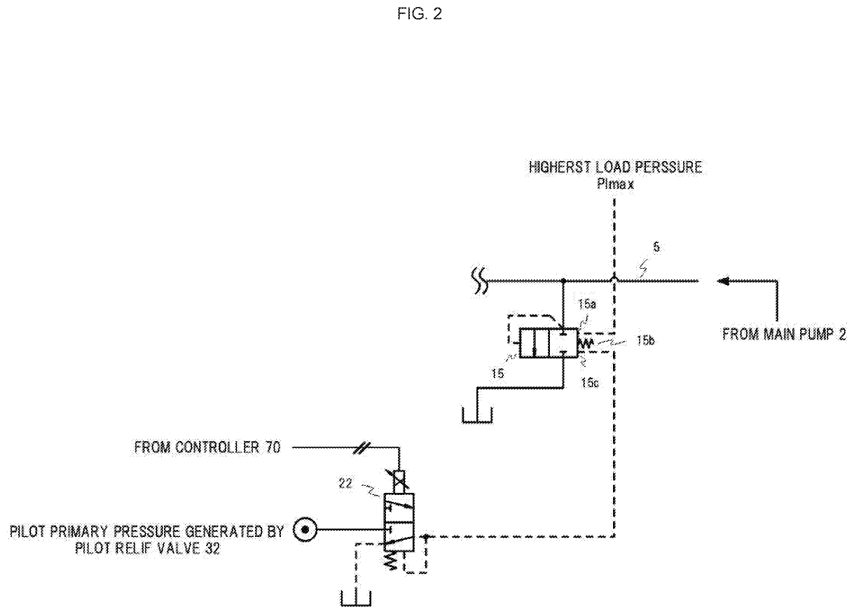

FIG. 2 is an enlarged view of peripheral elements of the unloading valve. The unloading valve 15 includes a pressure receiving portion 15a to which the highest load pressure of the plurality of actuators 3a, 3b, 3c, . . . is introduced in a direction in which the unloading valve 15 is closed, and a spring 15b. Further, the unloading valve 15 further includes a solenoid proportional pressure reducing valve 22 for generating a control pressure for the unloading valve 15, and the unloading valve 15 has a pressure receiving portion 15c to which an output pressure or control pressure of the solenoid proportional pressure reducing valve 22 is introduced in a direction in which the unloading valve 15 is to be closed.

The hydraulic drive system of the present embodiment includes a regulator 11 for controlling the displacement of the main pump 2 and a solenoid proportional pressure reducing valve 21 for causing the regulator 11 to generate a command pressure.

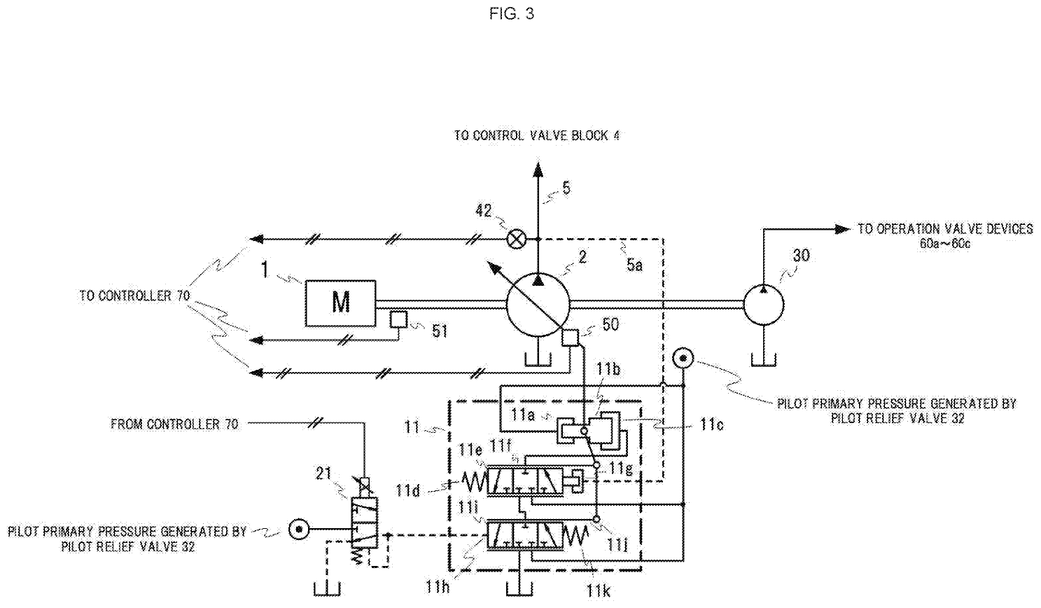

FIG. 3 is an enlarged view of peripheral elements of the main pump including the regulator 11. The regulator 11 includes a differential piston 11b that is driven by a pressure receiving area difference, a horsepower controlling tilting control valve 11e and a flow controlling tilting control valve 11i. A large diameter side pressure receiving chamber 11c of the differential piston 11b is connected to a line 31a, which is a pilot hydraulic fluid source and is a hydraulic fluid supply line to the pilot pump 30, or the flow controlling tilting control valve 11i through the horsepower controlling tilting control valve 11e. A small diameter side pressure receiving chamber 11a is normally connected to the line 31a, and the flow controlling tilting control valve 11i is configured so as to introduce the pressure of the line 31a or the tank pressure to the horsepower controlling tilting control valve 11e.

The horsepower controlling tilting control valve 11e includes a sleeve 11f that moves together with the differential piston lib, a spring 11d and a pressure receiving chamber 11g. The spring 11d is positioned on the side on which the flow controlling tilting control valve 11i and the large diameter side pressure receiving chamber 11c of the differential piston 11b are communicated with each other. To the pressure receiving chamber 11g, the pressure of the hydraulic fluid supply line 5 of the main pump 2 is introduced through a line 5a in a direction in which the line 31a and the small and large diameter side pressure receiving chambers 11a and 11c of the differential piston 11b are communicated with each other.

The flow controlling tilting control valve 11i includes a sleeve 11j that moves together with the differential piston lib, a pressure receiving portion 11h and a spring ilk. To the pressure receiving portion 11h, an output pressure or control pressure of the solenoid proportional pressure reducing valve 21 is introduced in a direction in which hydraulic fluid of the horsepower controlling tilting control valve 11e is discharged to the tank. The spring 11k is positioned on the side of the line 31a in which hydraulic fluid is introduced to the horsepower controlling tilting control valve 11e.

If the large diameter side pressure receiving chamber 11c is communicated with the line 31a through the horsepower controlling tilting control valve 11e and the flow controlling tilting control valve 11i, then the differential piston 11b is moved in a leftward direction in the figure by the pressure receiving area difference, but if the large diameter side pressure receiving chamber 11c is communicated with the tank through the horsepower controlling tilting control valve 11e and the flow controlling tilting control valve 11i, then the differential piston 11b is moved in the rightward direction in the figure by the force received from the small diameter side pressure receiving chamber 11a. If the differential piston 11b moves in the leftward direction in the figure, then the tilting angle of the main pump 2 of the variable displacement type, namely, the pump displacement, decreases to decrease the delivery flow rate of the main pump 2, but if the differential piston 11b moves in the rightward direction in the figure, then the tilting angle and the pump displacement of the main pump 2 increase to increase the delivery flow rate of the main pump 2.

A pilot relief valve 32 is connected to the hydraulic fluid supply line, namely, to the line 31a, of the pilot pump 30 such that a fixed pilot pressure Pi0 is generated in the line 31a by the pilot relief valve 32.

To the downstream of the pilot relief valve 32, pilot valves of a plurality of operation lever devices 60a, 60b, 60c, . . . for controlling the plurality of directional control valves 6a, 6b, 6c, . . . are connected through a selector valve 33. By operating the selector valve 33 by a gate lock lever 34 provided on a driver's seat 521 depicted in FIG. 4 of the construction machine such as a hydraulic excavator, it is switched whether the pilot pressure (Pi0) generated by the pilot relief valve 32 is to be supplied as a pilot primary pressure to the pilot valve of the plurality of operation lever devices 60a, 60b, 60c, . . . or hydraulic fluid of the pilot valve is to be discharged to the tank.

The hydraulic drive system of the present embodiment further includes a pressure sensor 40 for detecting the highest load pressure of the plurality of actuators 3a, 3b, 3c, . . . , pressure sensors 41a1 and 41a2 for detecting operation pressures a1 and a2 of the pilot valves of the operation lever device 60a for the boom cylinder 3a, pressure sensors 41b1 and 41b2 for detecting operation pressures b1 and b2 of the pilot valves of the operation lever device 60b for the arm cylinder 3b, a pressure sensor 41c for detecting operation pressures c1 and c2 of the pilot valves of the operation lever device 60c for the swing motor 3c, a pressure sensor not depicted for detecting an operation pressure of a pilot valve of an operation lever device for a different actuator not depicted, a pressure sensor 42 for detecting the pressure of the hydraulic fluid supply line 5 of the main pump 2, namely, the delivery pressure of the main pump 2, a tilting angle sensor 50 for detecting the tilting angle of the main pump 2, a speed sensor 51 for detecting the revolution speed of the prime mover 1, and a controller 70.

The controller 70 is configured from a microcomputer, which includes a CPU, a storage section configured from a ROM (Read Only Memory), a RAM (Random Access Memory), or a flash memory and so forth, and peripheral circuits of the microcomputer not depicted. The controller 70 acts in accordance with a program stored, for example, in the ROM.

The controller 70 receives detection signals of the pressure sensor 40, pressure sensors 41a1, 41a2, 41b1, 41b2, 41c, . . . , pressure sensor 42, tilting angle sensor 50 and speed sensor 51 as input signals thereto and outputs control signals to the solenoid proportional pressure reducing valves 21 and 22.

FIG. 4 depicts an appearance of a hydraulic excavator in which the hydraulic drive system described above is incorporated.

The hydraulic excavator includes an upper swing structure 502, a lower track structure 501, and a front work implement 504 of the swing type. The front work implement 504 is configured from a boom 511, an arm 512 and a bucket 513. The upper swing structure 502 is swingable with respect to the lower track structure 501 by rotation of the swing motor 3c. A swing post 503 is attached to a front portion of the upper swing structure, and the front work implement 504 is attached for upward and downward movement to the swing post 503. The swing post 503 is pivotally movable in a horizontal direction with respect to the upper swing structure 502 by expansion and contraction of the swing cylinder 3e, and the boom 511, arm 512 and bucket 513 of the front work implement 504 are pivotally movable in an upward and downward direction by expansion and contraction of the boom cylinder 3a, arm cylinder 3b and bucket cylinder 3d. To a middle frame 505 of the lower track structure 501, a blade 506 is attached which performs upward and downward actions by expansion and contraction of the blade cylinder 3h. The lower track structure 501 travels by rotation of the travelling motors 3f and 3g to drive left and right crawler belts.

An operation room 508 is provided on the upper swing structure 502, and in the operation room 508, the driver's seat 521, operation lever devices 60a, 60b, 60c and 60d for the boom cylinder 3a, arm cylinder 3b, bucket cylinder 3d and swing motor 3c, an operation lever device 60e for the swing cylinder 3e, an operation lever device 60h for the blade cylinder 3h, operation lever devices 60f and 60g for the travelling motors 3f and 3g and a gate lock lever 24 are provided at left and right front portions around the driver's seat 521.

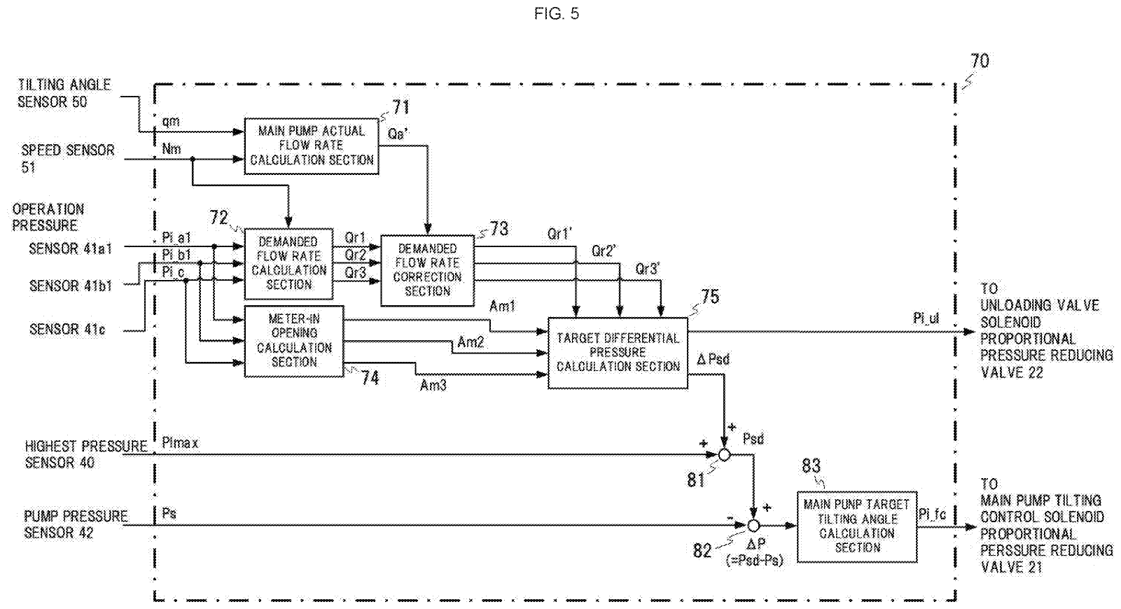

FIG. 5 depicts a functional block diagram of the controller 70 in the hydraulic drive system depicted in FIG. 1.

An output of the tilting angle sensor 50 indicative of the tilting angle of the main pump 2 and an output of the speed sensor 51 indicative of the revolution speed of the prime mover 1 are inputted to a main pump actual flow rate calculation section 71. An output of the speed sensor 51 and outputs of the pressure sensors 41a1, 41b1 and 41c indicative of lever operation amounts or operation pressures are inputted to a demanded flow rate calculation section 72. Further, outputs of the pressure sensors 41a1, 41b1 and 41c are inputted to a meter-in opening calculation section 74. It is to be noted that, in FIGS. 5 to 11 and the following description, “ . . . ” that suggests an element not depicted in FIG. 1 are sometimes omitted for simplification.

Further, an output Plmax of the pressure sensor 40 indicative of the highest load pressure of the plurality of actuators 3a, 3b, 3c, . . . is introduced to an adding section 81, and an output Ps of the pressure sensor 42 indicative of a delivery pressure or pump pressure of the main pump 2 is introduced to a differencing section 82.

Demanded flow rates Qr1, Qr2 and Qr3 that are outputs of the demanded flow rate calculation section 72 and a flow rate Qa′ that is an output of the main pump actual flow rate calculation section 71 are sent to a demanded flow rate correction section 73.

Outputs Qr1′, Qr2′ and Qr3′ of the demanded flow rate correction section 73 and outputs Am1, Am2 and Am3 of the meter-in opening calculation section 74 are sent to a target differential pressure calculation section 75.

The target differential pressure calculation section 75 outputs a command pressure or command value Pi_ul to the solenoid proportional pressure reducing valve 22 for the unloading valve and outputs a target differential pressure ΔPsd to the adding section 81.

The adding section 81 adds the target differential pressure ΔPsd and the highest load pressure Plmax to calculate a target pump pressure Psd=Plmax+ΔPsd and outputs the target pump pressure Psd to the differencing section 82.

The differencing section 82 subtracts the pump pressure or actual pump pressure Ps that is an output of the pressure sensor 42 from the target pump pressure Psd to calculate a differential pressure ΔP=Psd−Ps and outputs the differential pressure ΔP to a main pump target tilting angle calculation section 83.

The main pump target tilting angle calculation section 83 calculates a command pressure Pi_fc from the inputted differential pressure ΔP=Psd−Ps and outputs the command pressure Pi_fc as a command value to the solenoid proportional pressure reducing valve 21.

In the demanded flow rate calculation section 72, demanded flow rate correction section 73 and meter-in opening calculation section 74, and target differential pressure calculation section 75, the controller 70 calculates demanded flow rates for the plurality of actuators 3a, 3b and 3c and meter-in opening areas of the plurality of directional control valves 6a, 6b and 6c on the basis of input amounts of the operation levers of the plurality of operation lever devices 60a, 60b and 60c. Then, the controller 70 calculates the meter-in pressure loss of a particular directional control valve among the plurality of directional control valves 6a, 6b and 6c on the basis of the meter-in opening areas and the demanded flow rates and outputs the pressure loss as the target differential pressure ΔPsd to control the set pressure of the unloading valve 15.

Further, in the target differential pressure calculation section 75, the controller 70 selects a maximum value of the meter-in pressure loss of the plurality of directional control valves 6a, 6b and 6c as meter-in pressure loss of the particular directional control value, and outputs the pressure loss as the target differential pressure ΔPsd to control the set pressure of the unloading valve 15.

Furthermore, in the main pump target tilting angle calculation section 83, the controller 70 calculates a command value Pi_fc for making the delivery pressure of the main pump (namely, hydraulic pump) detected by the pressure sensor 42 equal to a sum of the highest load pressure detected by the highest load pressure detection device (namely, the shuttle valves 9a, 9b and 9c) and the target differential pressure, and outputs the command value Pi_fc to the regulator 11 (namely, a pump regulation device) to control the delivery flow rate of the main pump 2.

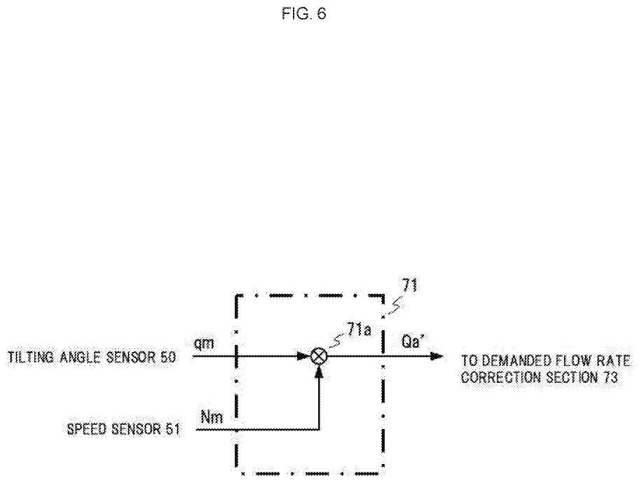

FIG. 6 depicts a functional block diagram of the main pump actual flow rate calculation section 71.

In the main pump actual flow rate calculation section 71, a tilting angle qm inputted from the tilting angle sensor 50 and a rotational speed Nm inputted from the speed sensor 51 are multiplied by a multiplier 71a to calculate a flow rate Qa′ actually delivered from the main pump 2.

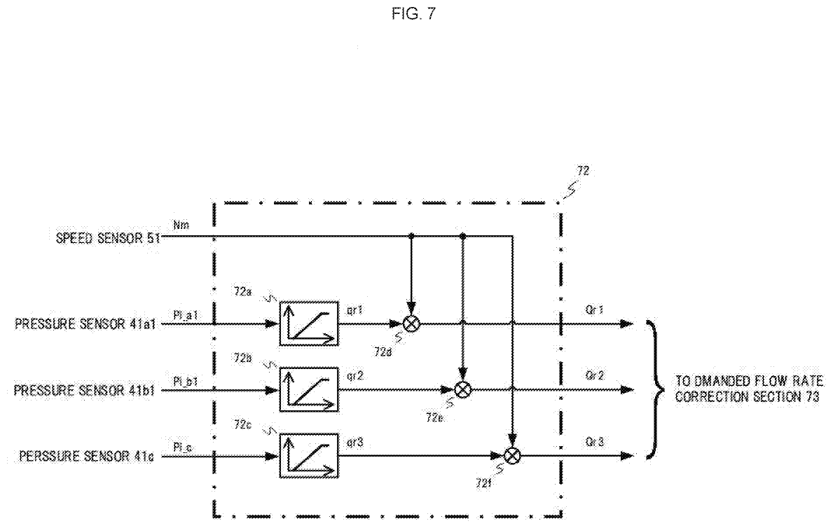

FIG. 7 depicts a functional block diagram of the demanded flow rate calculation section 72.

In the demanded flow rate calculation section 72, operation pressures Pi_a1, Pi_b1 and Pi_c inputted from the pressure sensors 41a1, 41b1 and 41c are converted into demanded flow rates qr1, qr2 and qr3 by tables 72a, 72b and 72c, respectively, and are multiplied by the rotational speed Nm inputted from the speed sensor 51 by multipliers 72d, 72e and 72f to calculate demanded flow rates Qr1, Qr2 and Qr3 for the plurality of actuators 3a, 3b, 3c, . . . , respectively.

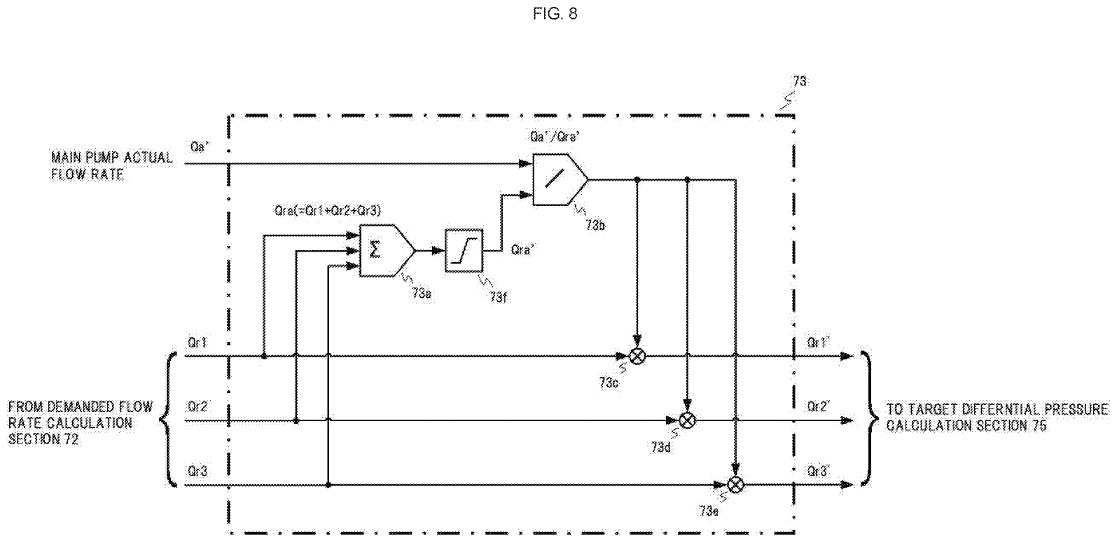

FIG. 8 depicts a functional block diagram of the demanded flow rate correction section 73.

In the demanded flow rate correction section 73, the demanded flow rates Qr1, Qr2 and Qr3 outputted from the demanded flow rate calculation section 72 are inputted to multiplier sections 73c, 73d and 73e and a summing section 73a, and a total value Qra of them is calculated by the summing section 73a. The total value Qra is inputted to the denominator side of a subtractor section 73b through a limiting section 73f that limits the total value Qra between a minimum value and a maximum value. Meanwhile, the flow rate Qa′ outputted from the main pump actual flow rate calculation section 71 is inputted to the numerator side of the subtractor section 73b, and the subtractor section 73b outputs the value of Qa′/Qra to the multiplier sections 73c, 73d and 73e. By the multiplier sections 73c, 73d and 73e, Qr1, Qr2 and Qr3 are multiplied by Qa′/Qra described above to calculate corrected demanded flow rates Qr1′, Qr2′ and Qr3′.

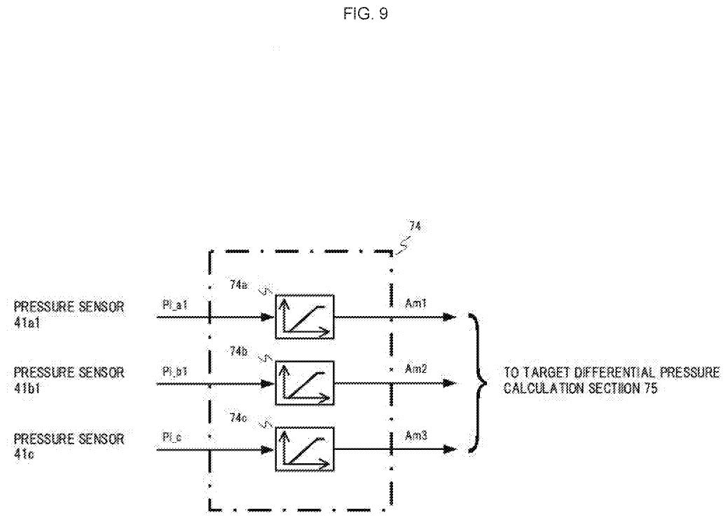

FIG. 9 depicts a functional block diagram of the meter-in opening calculation section 74.

In the meter-in opening calculation section 74, the operation pressures Pi_a1, Pi_b1 and Pi_c inputted from the pressure sensors 41a1, 41b1 and 41c are converted into meter-in opening areas Am1, Am2 and Am3 of the directional control valves by tables 74a, 74b and 74c, respectively. The tables 74a, 74b and 74c have stored therein in advance meter-in opening areas of the directional control valves 6a, 6b and 6c and are set such that, when the operation pressure is zero, zero is outputted and, as the operation voltage increases, an increasing value is outputted. Further, the maximum value of the meter-in opening areas is set to an extremely high value such that the meter-in pressure loss or LS differential pressure that is a pressure loss that possibly occurs at the meter-in openings of the directional control valves 6a, 6b and 6c becomes extremely small.

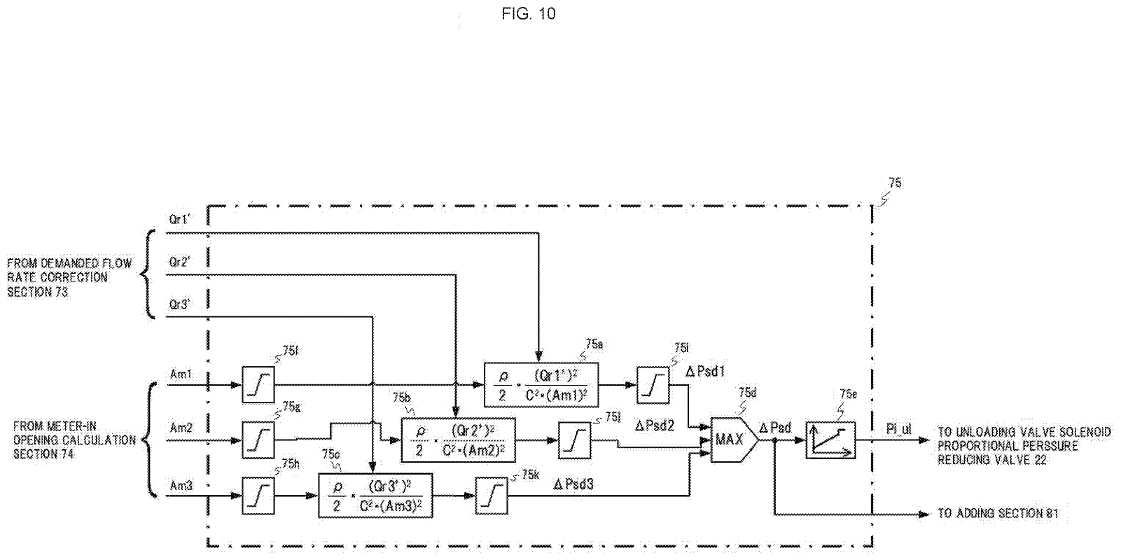

FIG. 10 depicts a functional block diagram of the target differential pressure calculation section 75.

Inputs Qr1′, Qr2′ and Qr3′ from the demanded flow rate correction section 73 are inputted to calculating sections 75a, 75b and 75c, respectively. Meanwhile, inputs Am1, Am2 and Am3 from the meter-in opening calculation section 74 are inputted to calculating sections 75a, 75b and 75c through limiting sections 75f, 75g and 75h, which limit the inputs between a minimum value and a maximum value. The calculating sections 75a, 75b and 75c use the inputs Qr1′, Qr2′ and Qr3′ and Am1, Am2 and Am3 to calculate meter-in pressure losses ΔPsd1, ΔPsd2 and ΔPsd3 of the directional control valves 6a, 6b and 6c by expressions given below. Here, C is a contraction coefficient determined in advance, and ρ is a density of hydraulic fluid.

$$Δ Psd 1 = \frac{ρ}{2} \cdot \frac{{( Qr {1}^{′} )}^{2}}{{C}^{2} \cdot {( Am 1 )}^{2}} \\ Δ Psd 2 = \frac{ρ}{2} \cdot \frac{{( Qr {2}^{′} )}^{2}}{{C}^{2} \cdot {( Am 2 )}^{2}} \\ Δ Psd 3 = \frac{ρ}{2} \cdot \frac{{( Qr {3}^{′} )}^{2}}{{C}^{2} \cdot {( Am 3 )}^{2}} \qquad [ Math . 1 ]$$

The pressure losses ΔPsd1, ΔPsd2 and ΔPsd3 are inputted to a maximum value selecting section 75d through limiting sections 75i, 75j and 75k that limit an input thereto between a minimum value and a maximum value. The maximum value selecting section 75d outputs a maximum one of the pressure losses ΔPsd1, ΔPsd2 and ΔPsd3 as a target differential pressure ΔPsd, which is an adjustment pressure for variably controlling the set pressure of the unloading valve 15, to the adding section 81. Further, the target differential pressure ΔPsd is converted into a command pressure Pi_ul by a table 75e and outputted as a command value to the solenoid proportional pressure reducing valve 22.

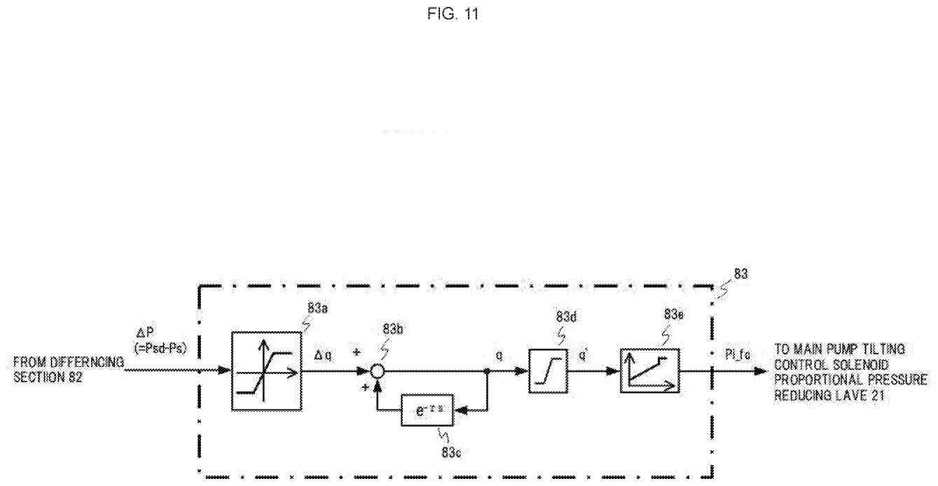

FIG. 11 depicts a functional block diagram of the main pump target tilting angle calculation section 83.

In the main pump target tilting angle calculation section 83, the differential pressure ΔP=Psd−Ps calculated by the differencing section 82 is inputted to a table 83a, by which it is converted into a target displacement change amount Δq. Δq is added by an adding section 83b to a target displacement q′ one control cycle before outputted from a delay element 83c and is outputted as a new target displacement q to a limiting section 83d. By the limiting section 83d, the target displacement q is limited to value between a minimum value and a maximum value therefor and is sent as a limited target displacement q′ to a table 83e. The target displacement q′ is converted into a command pressure Pi_fc to the solenoid proportional pressure reducing valve 21 by the table 83e and outputted as a command value.

˜Action˜

Action of the hydraulic drive system configured in such a manner as described above is described.

Hydraulic fluid delivered from the pilot pump 30 of the fixed displacement type is supplied to the hydraulic fluid supply line 31a, and a fixed pilot primary pressure Pi0 is generated in the hydraulic fluid supply line 31a by the pilot relief valve 32.

(a) Where all Operation Levers are Neutral

Since the operation levers for all operation lever devices 60a, 60b, 60c, . . . are neutral, all pilot valves are neutral, and the operation pressures a1, a2, b1, b2, c1, c2, . . . are equal to the tank pressure. Therefore, all directional control valves 6a, 6b, 6c, . . . are at their neutral position.

Since all directional control valves 6a, 6b and 6c are at the neutral position, the load pressure detection lines of the actuators are connected to the tank through the directional control values associated with the individual actuators.

Therefore, the tank pressure is detected as the highest load pressure Plmax through the shuttle valves 9a, 9b and 9c that are the highest load pressure detection device, and this highest load pressure Plmax is introduced to the pressure receiving portion 15a of the unloading valve 15 and the pressure sensor 40.

The boom raising operation pressure a1, arm crowding operation pressure b1 and swinging operation pressure c are detected by the pressure sensors 41a1, 41b1 and 41c, respectively, and outputs Pi_a1, Pi_b1 and Pi_c of the pressure sensors are sent to the demanded flow rate calculation section 72 and the meter-in opening calculation section 74.

The tables 72a, 72b and 72c of the demanded flow rate calculation section 72 have stored in advance therein reference demanded flow rates for each lever input for boom raising, arm crowding and swinging action, respectively, and are set such that, when the input is zero, zero is outputted, and as the input increases, an increasing value is outputted.

As described hereinabove, in the case where all operation levers are neutral, since the operation pressures Pi_a1, Pi_b1 and Pi_c are equal to the total tank pressure, all of the reference demanded flow rates qr1, qr2 and qr3 calculated by the tables 72a, 72b and 72c are zero. Since all of qr1, qr2 and qr3 are zero, demanded flow rates Qr1, Qr2 and Qr3 outputted from the multipliers 72d, 72e and 72f are zero.

Further, the tables 74a, 74b and 74c of the meter-in opening calculation section 74 have stored therein in advance meter-in opening areas of the directional control valves 6a, 6b and 6c, respectively, and are configured such that, when the input is zero, zero is outputted, and as the input increases, an increasing value is outputted.

As described hereinabove, in the case where all of the operation levers are neutral, since the operation pressures Pi_a1, Pi_b1 and Pi_c are equal to the total tank pressure, the meter-in opening areas Am1, Am2 and Am3 that are outputs of the tables 74a, 74b and 74c are zero.

The demanded flow rates Qr1, Qr2 and Qr3 are inputted to the demanded flow rate correction section 73.

The demanded flow rates Qr1, Qr2 and Qr3 inputted to the demanded flow rate correction section 73 are sent to the summing section 73a and the multiplier sections 73c, 73d and 73e.

The summing section 73a calculates Qra=Qr1+Qr2+Qr3, and in the case where all operation levers are neutral as described above, Qra=0+0+0.

The limiting section 73f performs limitation between a minimum value and a maximum value between which hydraulic fluid can be delivered from the main pump 2. Here, if the minimum value is represented by Qmin and the maximum value is represented by Qmax, then in the case where all operation levers are neutral, Qra=0<Qmin, and therefore, Qra is limited to Qmin by the limiting section 73f and Qra′=Qmin is sent to the denominator side of the subtractor section 73b.

On the other hand, as hereinafter described, in the case where all operation levers are neutral, since the main pump actual flow rate is kept to the minimum value Qmin, the subtractor section 73b outputs Qr′/Qr′=1 to the multiplier sections 73c, 73d and 73e.

As described hereinabove, in the case where all operation levers are neutral, since all of Qr1, Qr2 and Qr3 are zero, all of the outputs Qr1′, Qr2′ and Qr3′ of the multiplier sections 73c, 73d and 73e are 0×1=0.

The target differential pressure calculation section 75 calculates the pressure loss occurring at the meter-in opening of the directional control valves 6a, 6b and 6c from corrected demanded flow rates Qr1′, Qr2′ and Qr3′ and the meter-in opening areas Am1, Am2 and Am3 in accordance with the expressions given hereinabove.

First, the meter-in opening areas Am1, Am2 and Am3 are limited to minimum values Am1′, Am2′ and Am3′, which are determined in advance and are higher than zero, by the limiting sections 75f, 75g and 75h, respectively.

Although, in the case where all operation levers are neutral, all of the meter-in opening areas Am1, Am2 and Am3 and the corrected demanded flow rates Qr1′, Qr2′ and Qr3′ are zero as described hereinabove, since the meter-in opening areas Am1, Am2 and Am3 are limited to a certain value higher than zero as described hereinabove, the pressure losses ΔPsd1, ΔPsd2 and ΔPsd3 that are outputs of the calculating sections 75a, 75b and 75c are zero. The pressure losses ΔPsd1, ΔPsd2 and ΔPsd3 that are outputs of the calculating sections 75a, 75b and 75c are limited to a value equal to or higher than zero but equal to or lower than a maximum value ΔPsc_max determined in advance by the limiting sections 75i, 75j and 75k, respectively, and a maximum value of the pressure losses ΔPsd1, ΔPsd2 and ΔPsd3 is outputted as a target differential pressure ΔPsd from the maximum value selecting section 75d.

As described above, in the case where all operation levers are neutral, the target differential pressure ΔPsd is zero.

The target differential pressure ΔPsd is converted into a command value Pi_ul by the table 75e and is outputted as a command value to the solenoid proportional pressure reducing valve 22 for the unloading valve.

As described above, in the case where all operation levers are neutral, the highest load pressure Plmax is equal to the tank pressure.

Although the set pressure of the unloading valve 15 depends upon the highest load pressure Plmax introduced to the pressure receiving portion 15a, spring 15b and output pressure=ΔPsd of the solenoid proportional pressure reducing valve 22 introduced to the pressure receiving portion 15c, since both the highest load pressure Plmax and the output pressure=ΔPsd of the solenoid proportional pressure reducing valve 22 are equal to the tank pressure, the set pressure of the unloading valve 15 is kept to a very low value determined by the spring 15b.

Therefore, hydraulic fluid delivered from the main pump 2 of the variable displacement type is discharged from the unloading valve 15 to the tank, and the pressure of the hydraulic fluid supply line 5 is kept to the low pressure described above.

On the other hand, although the target differential pressure ΔPsd that is an output of the target differential pressure calculation section 75 is added to the highest load pressure Plmax by the adding section 81, since, in the case where all operation levers are neutral as described above, the target differential pressure ΔPsd is Plmax and ΔPsd is equal to the tank pressure zero, also the target pump pressure Psd that is an output of the target differential pressure calculation section 75 is zero.

The target pump pressure Psd and the pump pressure Ps detected by the pressure sensor 42 are sent to the positive side and the negative side of the differencing section 82 and are inputted as the difference ΔP=Psd−Ps between them to the main pump target tilting angle calculation section 83.

In the main pump target tilting angle calculation section 83, ΔP=Psd−Ps described above is converted into a target displacement change amount Δq by the table 83a. As depicted in FIG. 11, the table 83a is configured such that, when ΔP<0, Δq becomes Δq<0, when ΔP=0, Δq becomes Δq=0, and when ΔP>0, Δq becomes Δq>0, and, in the case where ΔP is greater or smaller by a certain amount or more, Δq is limited to a value determined in advance.

The target displacement change amount Δq becomes q by addition thereof to a target displacement q′ one control step before hereinafter described by the adding section 83b and is limited to a value between physical minimum and maximum values of the main pump 2 by the limiting section 83d and then outputted as a target displacement q′.

The target displacement q′ is converted into a command pressure Pi_fc to the solenoid proportional pressure reducing valve 21 by the table 83e to control the solenoid proportional pressure reducing valve 21.

As described hereinabove, in the case where all operation levers are neutral, Psd=highest load pressure Plmax+target differential pressure ΔPsd is equal to the tank pressure.

On the other hand, the pressure of the hydraulic fluid supply line 5, namely, the pump pressure Ps, is kept to a pressure higher by an amount defined by the spring 15b than the tank pressure by the unloading valve 15 as described hereinabove.

Therefore, in the case where all operation levers are neutral, since ΔP=Psd−Ps<0 is satisfied, ΔP becomes ΔP<0 by the table 83a. Although ΔP is added as new q to the adding section 83b and the target displacement q′ one step before obtained by the delay element 83c, since it is limited by minimum and maximum tilting the main pump 2 has by the limiting section 83d, the target displacement q′ one step before is kept to the minimum value.

(b) Where a Boom Raising Operation is Performed

A boom raising operation pressure a1 is outputted from the pilot valve of the operation lever device 60a for the boom. The boom raising operation pressure a1 is introduced to the directional control valve 6a and the pressure sensor 41a1, and the directional control valve 6a is shifted to the rightward direction in the figure.

Since the directional control valve 6a is shifted, the load pressure of the boom cylinder 3a is introduced as the highest load pressure Plmax to the unloading valve 15 and the pressure sensor 40 through the shuttle valve 9a.

Hydraulic fluid introduced from the hydraulic fluid supply line 5 to the directional control valve 6a is introduced to the upstream side of the pressure compensating valve 7a through the meter-in opening of the directional control valve 6a.

Although the pressure compensating valve 7a controls the pressure in the downstream side of the meter-in opening so as to become equal to the highest load pressure Plmax, in the case where boom raising is operated singly, since the highest load pressure Plmax is the load pressure of the boom cylinder 3a, the pressure compensating valve 7a is not throttled and the opening thereof is kept fully open.

The hydraulic fluid having passed the pressure compensating valve 7a is supplied to the bottom side of the boom cylinder 3a through the directional control valve 6a again. Since the hydraulic fluid is supplied to the bottom side of the boom cylinder 3a, the boom cylinder is expanded.

On the other hand, the boom raising operation pressure a1 is inputted as an output Pi_a1 of the pressure sensor 41a1 to the demanded flow rate calculation section 72, by which a demanded flow rate Qr1 is calculated.

Although, in response to inputs from the tilting angle sensor 50 and the speed sensor 51, the main pump actual flow rate calculation section 71 calculates a flow rate that is being delivered actually from the main pump 2, since, immediately after a boom raising operation is performed from the state in which all operation levers are neutral, the tilting of the variable displacement main pump 2 is kept to its minimum as described hereinabove in (a) the case in which all operation levers are neutral, also the pump actual flow rate Qa′ has the minimum value.

The demanded flow rate Qr1 is limited to the main pump actual flow rate Qa′ by the demanded flow rate correction section 73 and is corrected to Qr1′.

Meanwhile, the boom raising operation pressure a1 is sent as an output Pi_a1 of the pressure sensor 41a1 also to the meter-in opening calculation section 74, and it is converted into a meter-in opening area Am1 by the table 74a and outputted.

The target differential pressure calculation section 75 calculates a pressure loss, which occurs at the meter-in opening of each directional control valve, in accordance with the expressions given hereinabove from corrected demanded flow rates Qr1′, Qr2′ and Qr3′ and the meter-in opening areas Am1, Am2 and Am3.

In the case where a boom raising operation is performed, the corrected demanded flow rate Qr1′ and the meter-in opening area Am1 for boom operation are inputted to the calculating section 75a, by which the meter-in pressure loss ΔPsd1 of the directional control valve 6a is calculated in accordance with the following expression.

$$Δ Psd 1 = \frac{ρ}{2} \cdot \frac{{( Qr {1}^{′} )}^{2}}{{C}^{2} \cdot {( Am 1 )}^{2}} \qquad [ Math . 2 ]$$

Although the meter-in pressure losses ΔPsd2 and ΔPsd3 of the directional control valves 6b and 6c are calculated similarly, since ΔPsd2=ΔPsd3=0 is satisfied similarly as in the case where all levers are neutral, the pressure loss ΔPsd1 that is the maximum value is selected by the maximum value selecting section 75d, and ΔPsd=ΔPsd1 is established. The pressure loss ΔPsd1 is converted into a command pressure Pi_ul to the solenoid proportional pressure reducing valve 22 for the unloading valve by and outputted from the table 75e, and the target differential pressure ΔPsd is outputted to the adding section 81 simultaneously.

The output ΔPsd of the solenoid proportional pressure reducing valve 22 for the unloading valve is introduced to the pressure receiving portion 15c of the unloading valve 15 and acts to raise the set pressure of the unloading valve 15 by an amount corresponding to ΔPsd.

Since the load pressure Pl1 of the boom cylinder 3a is introduced as Plmax to the pressure receiving portion 15a of the unloading valve 15 as described above, the set pressure of the unloading valve 15 is set to Plmax+ΔPsd+spring force, namely, Pl1 (load pressure of the boom cylinder 3a)+ΔPsd (differential pressure generated at the meter-in opening of the directional control valve 6a for controlling the boom cylinder 3a)+spring force, and the hydraulic fluid supply line 5 interrupts the line for discharging to the tank.

On the other hand, although the adding section 81 adds the highest load pressure Plmax and the target differential pressure ΔPsd described above to calculate the target pump pressure Psd=Plmax+ΔPsd, in the case where a boom raising single operation is performed, since Plmax=Pl1, the target pump pressure Psd=pl1 (load pressure of the boom cylinder 3a)+ΔPsd (differential pressure generated at the meter-in opening of the directional control valve 6a for controlling the boom cylinder 3a) is calculated and outputted to the differencing section 82.

The differencing section 82 calculates the difference between the target pump pressure Psd described above and the pressure of the hydraulic fluid supply line 5, namely, the actual pump pressure Ps, detected by the pressure sensor 42 as ΔP=Psd−Ps and outputs the difference ΔP to the main pump target tilting angle calculation section 83.

In the main pump target tilting angle calculation section 83, the differential pressure ΔP is converted into the target displacement change amount Δq by the table 83a. However, in the case where a boom raising operation is performed from the state in which all levers are neutral, at the beginning of the action, the actual pump pressure Ps is kept to a value lower than the target pump pressure Psd, which is described in (a) Where all operation levers are neutral. Therefore, ΔP=Psd−Ps has a positive value.

Since the table 83a is configured so as to have a characteristic that, in the case where the differential pressure ΔP has a positive value, also the target displacement change amount Δq has a positive value, also the target displacement change amount Δq has a positive value.

Although the target displacement change amount Δq described above is added to the target displacement q′ one control step before to calculate new q by the adding section 83b and the delay element 83c, since the target displacement change amount Δq is in the positive as described above, the target displacement q′ increases.

Further, the target displacement q′ is converted into a command pressure Pi_fc to the solenoid proportional pressure reducing valve 21 for main pump tilting controlling by the table 83e, and the output=Pi_fc of the solenoid proportional pressure reducing valve 21 is introduced to the pressure receiving portion 11h of the flow controlling tilting control valve 11i in the regulator 11 of the main pump 2 such that the tilting angle of the main pump 2 is controlled so as to become equal to the target displacement q′.

Increase of the target displacement q′ and the delivery amount of the main pump 2 continues until after the actual pump pressure Ps becomes equal to the target pump pressure Psd, and finally, the actual pump pressure Ps is kept in a situation in which it is equal to the target pump pressure Psd.

In this manner, since the main pump 2 determines a pressure obtained by adding the pressure loss ΔPsd, which may possibly occur at the meter-in opening of the directional control valve 6a associated with the boom cylinder 3a, to the highest load pressure Plmax as a target pressure and increases or decreases the flow rate, load sensing control in which the target differential pressure is variable is performed.

(c) Where a Boom Raising Operation and an Arm Crowding Operation are Performed Simultaneously

A boom raising operation pressure a1 is outputted from the pilot valve of the operation lever device 60a for the boom and an arm crowding operation pressure b1 is outputted from the pilot valve of the operation lever device 60b.

The boom raising operation pressure a1 is introduced to the directional control valve 6a and the pressure sensor 41a1, and the directional control valve 6a is shifted to the rightward direction in the figure.

The arm crowding operation pressure b1 is introduced to the directional control valve 6b and the pressure sensor 41b1, and the directional control valve 6b is shifted to the rightward direction in the figure.

Since the directional control valves 6a and 6b are shifted, the load pressure of the boom cylinder 3a is introduced to the shuttle valve 9a through the directional control valve 6a and the load pressure of the arm cylinder 3b is introduced to the shuttle valve 9a through the directional control valve 6b and the shuttle valve 9b.

The shuttle valve 9a selects a higher one of the load pressure of the boom cylinder 3a and the load pressure of the arm cylinder 3b as the highest load pressure Plmax. In the case where action in the air is assumed, since normally the condition of the load pressure of the boom cylinder 3a>load pressure of the arm cylinder 3b is satisfied rather frequently, if the case of the load pressure of the boom cylinder 3a>load pressure of the arm cylinder 3b is considered, then the highest load pressure Plmax is equal to the load pressure of the boom cylinder 3a.

The highest load pressure Plmax is introduced to the pressure receiving portion 15a of the unloading valve 15 and the pressure sensor 40.

The pressure compensating valve 7a associated with the boom cylinder 3a controls the pressure in the downstream side of the meter-in opening of the directional control valve 6a associated with the boom cylinder 3a so as to be equal to the highest load pressure Plmax. However, in the case where the load pressure of the boom cylinder 3a>load pressure of the arm cylinder 3b is satisfied, since the highest load pressure Plmax=the load pressure of the boom cylinder 3a, the pressure compensating valve 7a is not throttled and the opening thereof is kept fully open.

Further, the pressure compensating valve 7b associated with the arm cylinder 3b controls the pressure in the downstream side of the meter-in opening of the directional control valve 6b associated with the arm cylinder 3b so as to become equal to the highest load pressure Plmax, namely, in this case, equal to the load pressure of the boom cylinder 3a. Consequently, the pressure in the downstream side of the meter-in opening of the directional control valve 6b is kept to Plmax=load pressure of the boom cylinder 3a.

Since the differential pressures across the directional control valves 6a and 6b, namely, the pump pressures that are common and the downstream side pressures of the meter-in openings are kept equal to each other, the directional control valves 6a and 6b distribute hydraulic fluid of the hydraulic fluid supply line 5 in response to the magnitude of the meter-in openings without depending upon the magnitude of the load pressures of the boom cylinder 3a and the arm cylinder 3b.

The hydraulic fluid having passed the pressure compensating valves 7a and 7b is supplied to the bottom side of the boom cylinder 3a and the bottom side of the arm cylinder 3b through the directional control valves 6a and 6b again, respectively.

Since hydraulic fluid is supplied to the bottom side of the boom cylinder 3a and the bottom side of the arm cylinder 3b, the boom cylinder and the arm cylinder are extended.

On the other hand, the boom raising operation pressure a1 and the arm crowding operation pressure b1 are inputted as outputs Pi_a1 and Pi_b1 of the pressure sensors 41a1 and 41b1 to the demanded flow rate calculation section 72, by which demanded flow rates Qr1 and Qr2 are calculated, respectively.

Although the main pump actual flow rate calculation section 71 calculates the flow rate actually delivered from the main pump 2 in response to inputs from the tilting angle sensor 50 and the speed sensor 51, immediately after boom raising and arm crowding operations are performed from the state in which all operation levers are neutral, the tilting of the variable displacement main pump 2 is kept to its minimum as described hereinabove in connection with the case (a) Where all operation levers are neutral. Therefore, also the flow rate Qa′ is kept to the lowest value.

In the demanded flow rate correction section 73, the boom raising demanded flow rate Qr1 and the arm crowding demanded flow rate Qr2 are sent to the summing section 73a, by which Qra=Qr1+Qr2+Qr3=Qr1+Qr2 is calculated.

Qra calculated by the summing section 73a is limited to a value within a range of the limiting section 73f, and thereafter, division Qa′/Qra of the output of the main pump actual flow rate calculation section 71 and the main pump flow rate Qa′ is performed by the subtractor section 73b. An output of the subtractor section 73b is sent to the multiplier sections 73c, 73d and 73e.

In short, in the demanded flow rate correction section 73, the boom raising demanded flow rate Qr1 and the arm crowding demanded flow rate Qr2 are re-distributed at the ratio of Qr1 and Qr2 within the range of the flow rate Qa′ that is actually delivered from the main pump 2.

For example, in the case where Qa′ is 30 L/min, Qr1 is 20 L/min and Qr2 is 40 L/min, since Qra=Qr1+Qr2+Qr3=60 L/min, Qa′/Qra=½ is established.

The corrected boom raising demanded flow rate Qr1′ becomes Qr1′=Qr1×½=20 L/min×½=10 L/min, and the corrected arm crowding demanded flow rate Qr2′ becomes Qr2′=Qr2×½=40 L/min×½=20 L/min.

The boom raising operation pressure a1 and the arm crowding operation pressure b1 are sent as outputs Pi_a1 and Pi_b1 of the pressure sensors 41a1 and 41b1 also to the meter-in opening calculation section 74, by which they are converted into and outputted as meter-in opening areas Am1 and Am2 by and from the tables 74a and 74b, respectively.

The target differential pressure calculation section 75 calculates pressure losses ΔPsd1, ΔPsd2 and ΔPsd3 to be generated at the meter-in opening of the directional control valves from the corrected demanded flow rates Qr1′, Qr2′ and Qr3′ and the meter-in opening areas Am1, Am2 and Am3.

In the case where a boom raising action and an arm crowding operation are performed simultaneously, the corrected demanded flow rates Qr1′ and Qr2′ and the meter-in opening areas Am1 and Am2 are inputted to the calculating sections 75a and 75b, by which ΔPsd1 and ΔPsd2 are calculated in accordance with the following expressions.

$$Δ Psd 1 = \frac{ρ}{2} \cdot \frac{{( Qr {1}^{′} )}^{2}}{{C}^{2} \cdot {( Am 1 )}^{2}} \\ Δ Psd 2 = \frac{ρ}{2} \cdot \frac{{( Qr {2}^{′} )}^{2}}{{C}^{2} \cdot {( Am 2 )}^{2}} \qquad [ Math . 3 ]$$

Although also ΔPsd3 is calculated similarly, since ΔPsd3=0 similarly as in the case where all levers are neutral, a higher one of ΔPsd1 and ΔPsd2 is selected as ΔPsd by the maximum value selecting section 75d and is converted into a command pressure Pi_ul to the solenoid proportional pressure reducing valve 22 for the unloading valve by the table 75e and outputted as a command value. Meanwhile, ΔPsd is outputted to the adding section 81.

An output of the solenoid proportional pressure reducing valve 22 for the unloading valve is introduced to the pressure receiving portion 15c of the unloading valve 15 and acts to increase the set pressure of the unloading valve 15 by ΔPsd.

As described hereinabove, in the case where the load pressure of the boom cylinder 3a>load pressure of the arm cylinder 3b is satisfied, since the load pressure Pl1 of the boom cylinder 3a is introduced as Plmax to the pressure receiving portion 15a of the unloading valve 15, the set pressure of the unloading valve 15 is set to Plmax+ΔPsd+spring force, namely, Pl1 (load pressure of the boom cylinder 3a)+ΔPsd (a greater one of the differential pressure generated at the meter-in opening of the directional control valve 6a associated with the boom cylinder 3a and the differential pressure generated at the meter-in opening of the directional control valve 6b associated with the arm cylinder 3b)+spring force, and interrupts the line along which hydraulic fluid of the hydraulic fluid supply line 5 is discharged to the tank.

On the other hand, although the adding section 81 adds the highest load pressure Plmax and ΔPsd described above to calculate the target pump pressure Psd=Plmax+ΔPsd, in the case where the load pressure of the boom cylinder 3a>load pressure of the arm cylinder 3b, since Plmax=Pl1 as described hereinabove, the target pump pressure Psd=Pl1 (load pressure of the boom cylinder 3a)+ΔPsd (a greater one of the differential pressure generated at the meter-in opening of the directional control valve 6a associated with the boom cylinder 3a and the differential pressure generated at the meter-in opening of the directional control valve 6b associated with the arm cylinder 3b) is calculated and outputted to the differencing section 82.

The differencing section 82 calculates the difference between the target pump pressure Psd described above and the pressure of the hydraulic fluid supply line 5 detected by the pressure sensor 42, namely, the actual pump pressure Ps, as ΔP=Psd−Ps and outputs it to the main pump target tilting angle calculation section 83.

Although, in the main pump target tilting angle calculation section 83, the differential pressure ΔP is converted into a target displacement change amount Δq by the table 83a, in the case where a boom raising operation and an arm crowding operation are performed from the state in which all levers are neutral, since, at the beginning of action, the actual pump pressure Ps is kept to a value smaller than the target pump pressure Ps, which is described in the case (a) Where all operation levers are neutral, ΔP=Psd−Ps has a positive value.

Since the table 83a has such a characteristic that, in the case where the differential pressure ΔP has a positive value, also the target displacement change amount Δq has a positive value, also the target displacement change amount Δq becomes positive.

Although the adding section 83b and the delay element 83c add the target displacement change amount Δq described above to the target displacement q′ one control step before to calculate new q, since the target displacement change amount Δq is in the positive as described above, the target displacement q′ increases.

Further, the target displacement q′ is converted into a command pressure or command value Pi_fc to the solenoid proportional pressure reducing valve 21 for main pump tilting controlling by the table 83e. The output Pi_fc of the solenoid proportional pressure reducing valve 21 for main pump tilting controlling is introduced to the pressure receiving portion 11h of the flow controlling tilting control valve 11i for flow rate controlling in the regulator 11 of the variable displacement main pump 2, and the tilting angle of the variable displacement main pump 2 is controlled so as to become equal to the target displacement q′.

Increase of the target displacement q′ and the delivery amount of the variable displacement main pump 2 continues until after the actual pump pressure Ps becomes equal to the target pump pressure Psd, and finally, the actual pump pressure Ps is kept in a situation in which it is equal to the target pump pressure Psd.

In this manner, the variable displacement main pump 2 compares a pressure loss that may possibly occur at the meter-in opening of the directional control valve 6a associated with the boom cylinder 3a and a pressure loss that may possibly occur at the meter-in opening of the directional control valve 6b associated with the arm cylinder 3b with each other, calculates a greater one as a target differential pressure ΔPsd, and increases or decreases the flow rate using a pressure of addition of the target differential pressure ΔPsd to the highest load pressure Plmax as a target pressure. Therefore, load sensing control in which the target differential pressure is variable is performed.

˜Advantage˜

According to the present embodiment, the following advantages are obtained.

1. In the present embodiment, since the hydraulic drive system is configured such that flow dividing control of the plurality of the directional control valves 6a, 6b and 6c is performed by using the plurality of pressure compensating valves (namely, flow sharing valves) 7a, 7b and 7c arranged in the downstream side of the plurality of directional control valves 6a, 6b and 6c for controlling the pressure in the downstream side of the meter-in openings of the plurality of directional control valves 6a, 6b and 6c such that the pressures in the downstream sides of the meter-in openings of the plurality of directional control valves 6a, 6b and 6c becomes equal to the highest load pressure, even in the case where the differential pressures, namely, the meter-in pressure losses, across the directional control valves 6a, 6b and 6c associated with the actuators 3a, 3b and 3c are very small, flow dividing control of the plurality of directional control valves 6a, 6b and 6c can be performed stably.

2. Further, in the present embodiment, the controller 70 calculates a meter-in pressure loss of each of the directional control valves 6a, 6b and 6c associated with the actuators 3a, 3b and 3c, selects a maximum value of the meter-in pressure losses (namely, calculates the meter-in pressure loss of a specific directional control valve), and outputs the pressure loss of the maximum value as the target differential pressure ΔPsd to control the set pressure Plmax+ΔPsd+spring force of the unloading valve 15. Consequently, since the set pressure of the unloading valve 15 is controlled to the sum value of the highest load pressure, the target differential pressure ΔPsd therefor and the spring force, for example, even in the case where the meter-in opening of an actuator that is not the highest load pressure actuator is throttled extremely small by the directional control valve associated with the actuator, the set pressure of the unloading valve 15 is controlled carefully in response to the pressure loss at the meter-in opening of the directional control valve. As a result, even in the case where the demanded flow rate changes suddenly at the time of transition from a combined operation including a half operation of an operation lever corresponding to the directional control valve whose meter-in loss indicates a maximum value to a half single operation or in a like case and the pump pressure increases suddenly due to insufficient responsiveness of pump flow rate control, bleed-off loss in which hydraulic fluid is discharged uselessly from the unloading valve 15 to the tank can be suppressed to the minimum and reduction of the energy efficiency can be suppressed and besides a sudden change of the actuator speed by a sudden change of the flow rate of the hydraulic fluid supplied to each actuator can be prevented to suppress occurrence of an unpleasant shock thereby implement superior combined operability.

3. Further, in the present embodiment, even in the case where the differential pressure across each of the directional control valves 6a, 6b and 6c is very small as described above, flow dividing control of the plurality of directional control valves 6a, 6b and 6c can be performed stably. Besides, since the set pressure of the unloading valve 15 can be controlled carefully in response to the pressure loss at the meter-in opening of each of the directional control valves 6a, 6b and 6c, it becomes possible to make the final meter-in opening of each of the directional control valves 6a, 6b and 6c, namely, the meter-in opening area at a full stroke of the main spool, extremely great. Consequently, it is possible to reduce the meter-in loss and implement a high energy efficiency.

4. In such conventional load sensing control as disclosed in Patent Document 1, a hydraulic pump increases or decreases the delivery flow rate thereof such that the LS differential pressure becomes equal to a target LS differential pressure determined in advance. However, in the case where the meter-in final opening of the main spool is made extremely great, the LS differential pressure becomes substantially equal to zero as described hereinabove. Therefore, the conventional load sensing control has a problem that the hydraulic pump delivers a maximum flow rate within an allowable range, resulting in failure to perform flow rate control according to each operation lever input.

In the present embodiment, the controller 70 calculates a target differential pressure ΔPsd for adjusting the set pressure of the unloading valve 15 and controls the delivery flow rate of the main pump 2 using the target differential pressure ΔPsd such that the delivery pressure of the main pump 2 detected by the pressure sensor 42 becomes equal to the sum of the highest load pressure and the target differential pressure ΔPsd. Therefore, even if the final meter-in opening of each of the directional control valves 6a, 6b and 6c is made extremely great, such a problem that pump flow rate control cannot be performed as in the case in which the LS differential pressure is set to zero in the conventional load sensing control does not occur, and the delivery flow rate of the main pump 2 can be controlled in response to an operation lever input.

5. Furthermore, since the main pump 2 performs load sensing control that takes the meter-in pressure loss into consideration and each actuator delivers required hydraulic fluid to the main pump 2 just enough in response to an input of each operation lever, a hydraulic system in which the energy efficiency is high in comparison with flow rate control, in which the target flow rate is determined simply depending upon each operation lever input can be implemented.

6. Further, in comparison with the conventional technology disclosed in Patent Document 2, the quantity of solenoid proportional pressure reducing valves and pressure sensors for load pressure detection of each actuator can be suppressed, and the cost relating to electronic control can be suppressed.

### Second Embodiment

A hydraulic drive system for a construction machine according to a second embodiment of the present invention is described below focusing on differences thereof from the first embodiment.

˜Structure˜

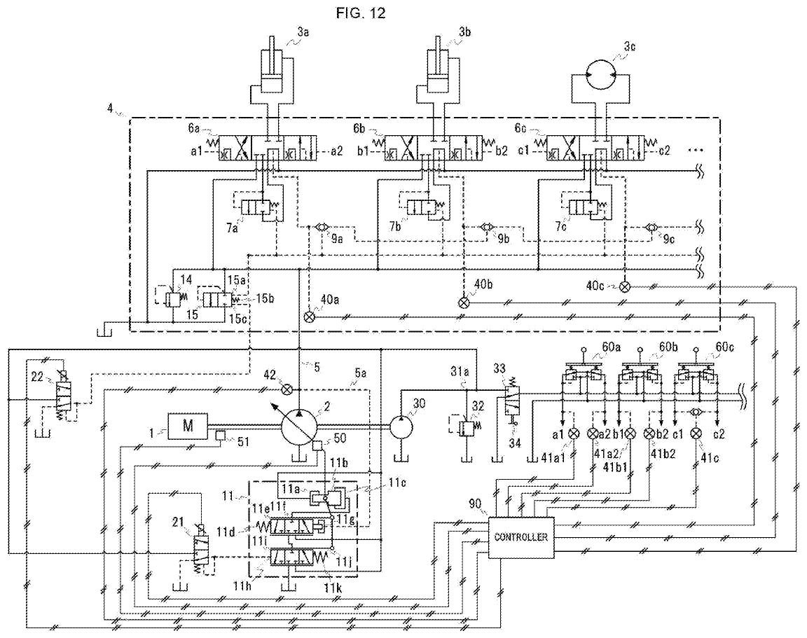

FIG. 12 is a view depicting a structure of the hydraulic drive system for a construction machine according to the second embodiment.

Referring to FIG. 12, the second embodiment is configured such that, in the first embodiment, the pressure sensor 40 for detecting the highest load pressure is removed and pressure sensors 40a, 40b and 40c for detecting a load pressure of a plurality of actuators 3a, 3b, 3c, . . . are provided and besides a controller 90 is provided in place of the controller 70.

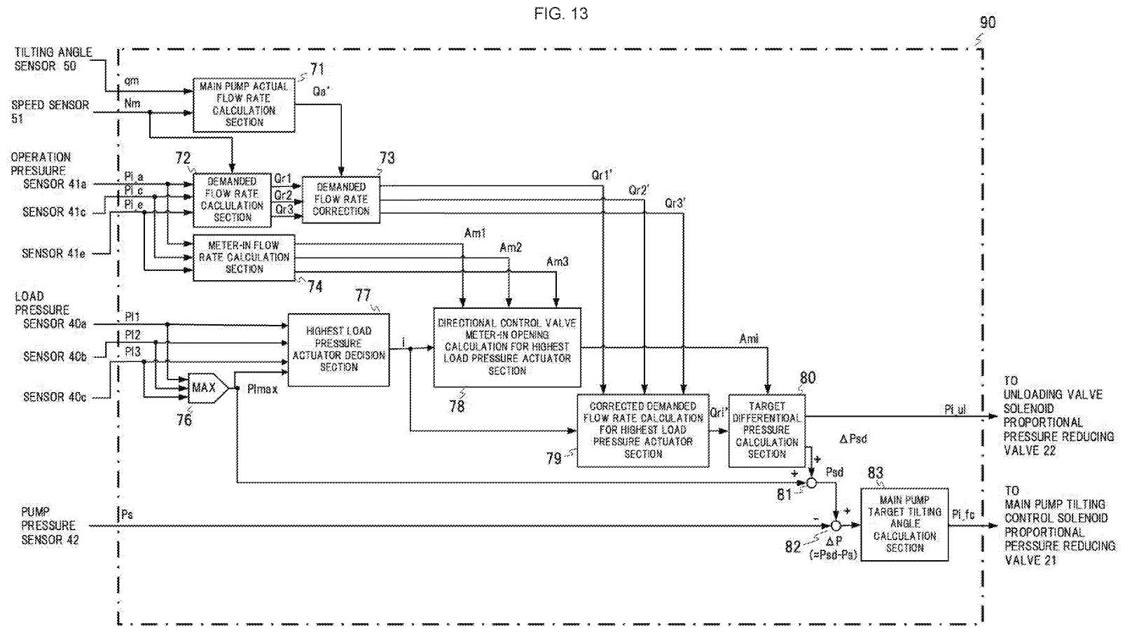

FIG. 13 depicts a functional block diagram of the controller 90 in the present embodiment.

Referring to FIG. 13, the difference from the first embodiment depicted in FIG. 5 resides in that, in place of the target differential pressure calculation section 75, a maximum value selecting section 76, a highest load pressure actuator decision section 77, a directional control valve meter-in opening calculation section 78 for the highest load pressure actuator, a corrected demanded flow rate calculation section 79 for the highest load pressure actuator and a target differential pressure calculation section 80 are provided. In the following, such functions are described.

Referring to FIG. 13, outputs of the pressure sensors 40a, 40b and 40c indicative of load pressures of the actuators are sent to the maximum value selecting section 76 and the highest load pressure actuator decision section 77.

The highest load pressure Plmax that is an output of the maximum value selecting section 76 is sent to the highest load pressure actuator decision section 77 together with outputs Pl1, Pl2 and Pl3 of the pressure sensors 40a, 40b and 40c described hereinabove, and the highest load pressure actuator decision section 77 sends an identifier i indicative of the highest load pressure actuator to the directional control valve meter-in opening calculation section 78 of the highest load pressure actuator and a corrected demanded flow rate calculation section 79 of the highest load pressure actuator. Further, the highest load pressure Plmax is sent to the adding section 81.

The directional control valve meter-in opening calculation section 78 of the highest load pressure actuator receives the identifier i and meter-in opening areas Am1, Am2 and Am3 that are outputs of the meter-in opening calculation section 74 as inputs thereto and outputs a meter-in opening area Ami for the directional control valve of the highest load pressure actuator.

The corrected demanded flow rate calculation section 79 of the highest load pressure actuator receives the identifier i and the corrected demanded flow rages Qr1′, Qr2′ and Qr3′ that are outputs of the demanded flow rate correction section 73 as inputs thereto and outputs a corrected demanded flow rate Qri′ of the highest load pressure actuator.

The meter-in opening area Ami of the directional control valve of the highest load pressure actuator and the corrected demanded flow rate Qri′ of the highest load pressure actuator are sent to the target differential pressure calculation section 80, and the target differential pressure calculation section 80 outputs a target differential pressure ΔPsd to the adding section 81 and outputs a command pressure or command value Pi_ul to the solenoid proportional pressure reducing valve 22.

In the demanded flow rate calculation section 72, demanded flow rate correction section 73 and meter-in opening calculation section 74, maximum value selecting section 76, highest load pressure actuator decision section 77, directional control valve meter-in opening calculation section 78, corrected demanded flow rate calculation section 79 and target differential pressure calculation section 80, the controller 90 calculate a demanded flow rate for each of the plurality of the actuators 3a, 3b and 3c and a meter-in opening area of each of the plurality of directional control valves 6a, 6b and 6c on the basis of input amounts of the operation levers of the plurality of operation lever devices 60a, 60b and 60c, calculate a meter-in pressure loss of a specific directional control valve in the plurality of the directional control valves 6a, 6b and 6c on the basis of the meter-in opening areas and the demanded flow rates, and output the pressure loss as a target differential pressure ΔPsd to control the set pressure of the unloading valve 15.

Further, in the maximum value selecting section 76, highest load pressure actuator decision section 77, directional control valve meter-in opening calculation section 78, corrected demanded flow rate calculation section 79 and target differential pressure calculation section 80, the controller 90 calculate, as a meter-in pressure loss of the specific directional control valve, a meter-in pressure loss of a directional control valve associated with the actuator of the highest load pressure detected by the highest load pressure detection device (namely by the shuttle valves 9a, 9b and 9c) in the plurality of directional control valves 6a, 6b and 6c, and outputs the pressure loss as the target differential pressure ΔPsd to control the set pressure of the unloading valve 15.

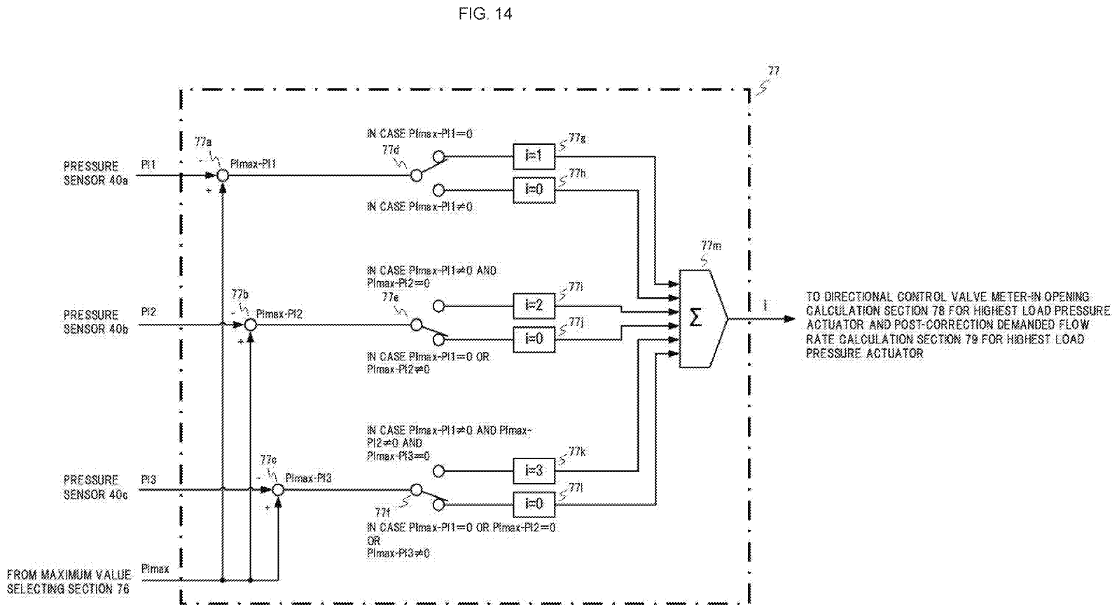

FIG. 14 depicts a functional block diagram of the highest load pressure actuator decision section 77.

In the decision section 77, load pressures Pl1, Pl2 and Pl3 of the actuators inputted from the pressure sensors 40a, 40b and 40c are sent to the negative side of differencing sections 77a, 77b and 77c while the highest load pressure Plmax from the maximum value selecting section 76 is sent to the positive side of the differencing sections 77a, 77b and 77c, and the differencing sections 77a, 77b and 77c output Plmax−Pl1, Plmax−Pl2 and Plmax−Pl3 to deciding sections 77d, 77e and 77f, respectively. Each of the deciding sections 77d, 77e and 77f is switched to an ON state, in the figure, to the upper side, in the case where the decision sentence is true but is switched to an OFF state, in the figure, to the lower side, in the case where the decision sentence is false.

Since FIG. 14 depicts a case of Plmax=Pl1, namely, a case where Plmax−Pl1 is zero, in this case, the calculating section 77g is selected and i=1 is outputted as the identifier i to a summing section 77m. On the other hand, since, in the deciding sections 77e and 77f, the decision state is false, calculating sections 77j and 771 are selected, respectively, and i=0 is sent as the identifier i to the summing section 77m. The summing section 77m sums up the outputs of the calculating sections 77g, 77j and 771 and outputs i=1.

In this manner, in the case of Plmax=Pl1, i=1 is outputted. Similarly, in the case of Plmax=Pl2, i=2 is outputted, and in the case of Plmax=Pl3, i=3 is outputted.

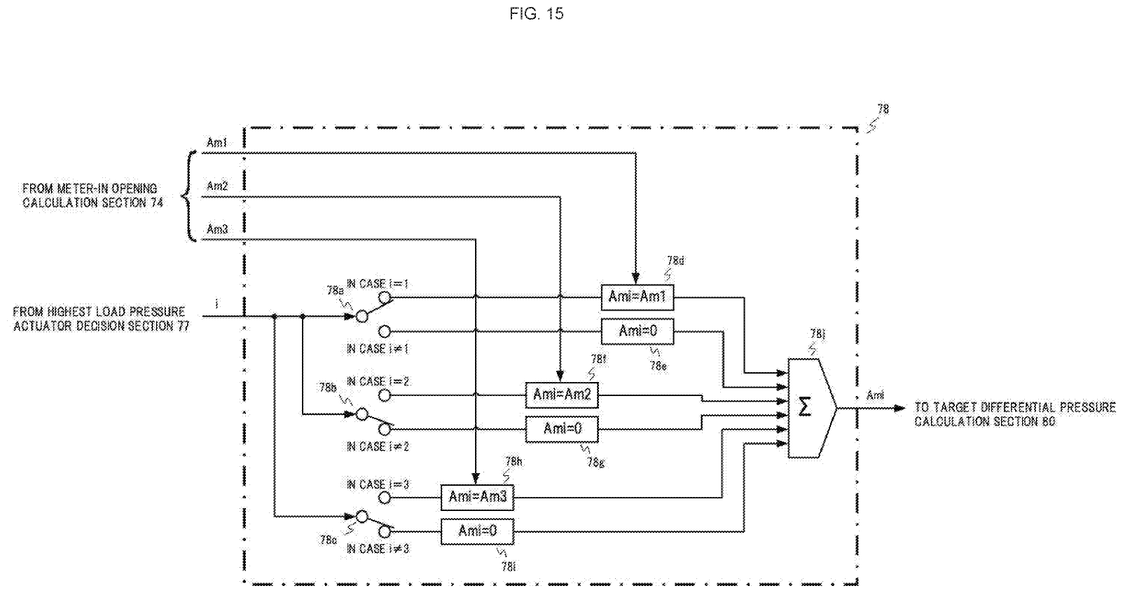

FIG. 15 depicts a functional block diagram of the directional control valve meter-in opening calculation section 78 of the highest load pressure actuator.

In the calculation section 78, the identifier i inputted from the highest load pressure actuator decision section 77 is sent to deciding sections 78a, 78b and 78c while meter-in opening areas Am1, Am2 and Am3 inputted from the meter-in opening calculation section 74 are sent to the deciding sections 78d, 78f and 78h, respectively. FIG. 15 depicts a case of i=1.

Since i=1, the deciding section 78a indicates an ON state an is switched to the upper side in the figure, by which the calculating section 78d is selected and sends Am1 as the meter-in opening area Ami to a summing section 78j. Meanwhile, the deciding sections 78b and 78c are in an OFF state and are switched to the lower state in the figure, by which calculating sections 78g and 78i are selected and both send zero as the meter-in opening area Ami to the summing section 78j. The summing section 78j outputs Am1+0+0=Am1 as the meter-in opening area Ami.

Similarly, in the case of i=2, Am2 is outputted, and in the case of i=3, Am3 is outputted, as the meter-in opening area Ami.

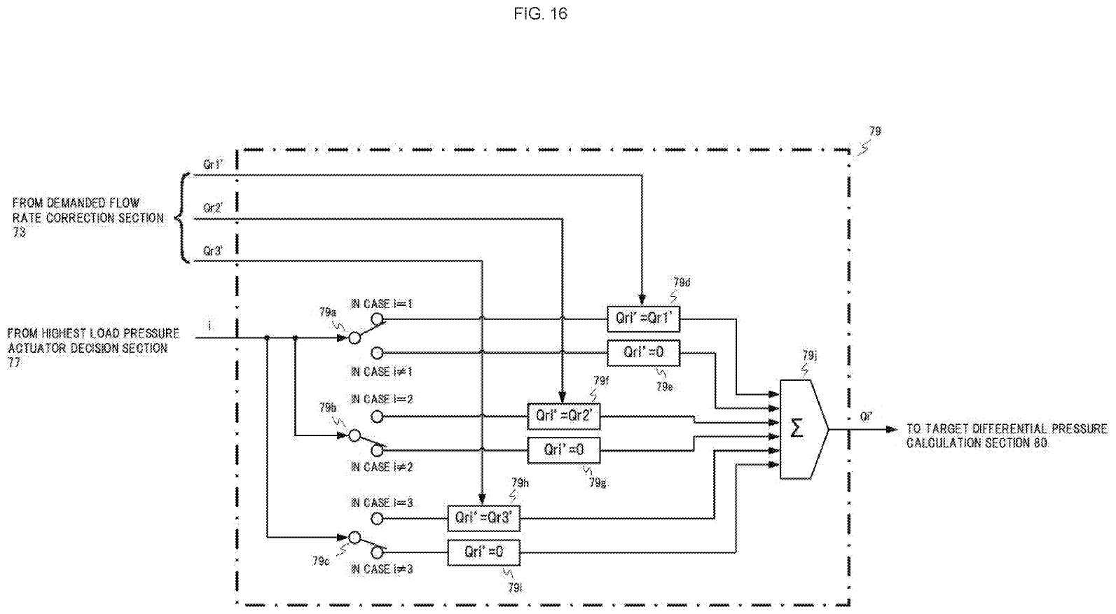

FIG. 16 depicts a functional block diagram of the corrected demanded flow rate calculation section 79 of the highest load pressure actuator.

In the calculation section 79, an identifier i inputted from the highest load pressure actuator decision section 77 is sent to deciding sections 79a, 79b and 79c while corrected demanded flow rates Qr1′, Qr2′ and Qr3′ inputted from the demanded flow rate correction section 73 are sent to calculating sections 79d, 79g and 79h, respectively. FIG. 16 depicts a case of i=1.

Since i=1, the deciding section 79a indicates an ON state and is switched to the upper side in the figure, and the calculating section 79d is selected and sends Qr1′ as the corrected demanded flow rate Qri′ to a summing section 79j. Meanwhile, the deciding sections 79b and 79c indicate an OFF state and are switched to the lower side in the figure, and the calculating sections 79g and 79i are selected and both send zero as the corrected demanded flow rate Qri′ to the summing section 79j. The summing section 79j outputs Qr1′+0+0 as the corrected demanded flow rate Qri′.

Similarly, in the case of i=2, Qr2′ is outputted, and in the case of i=3, Qr3′ is outputted, as the corrected demanded flow rate Qri′.

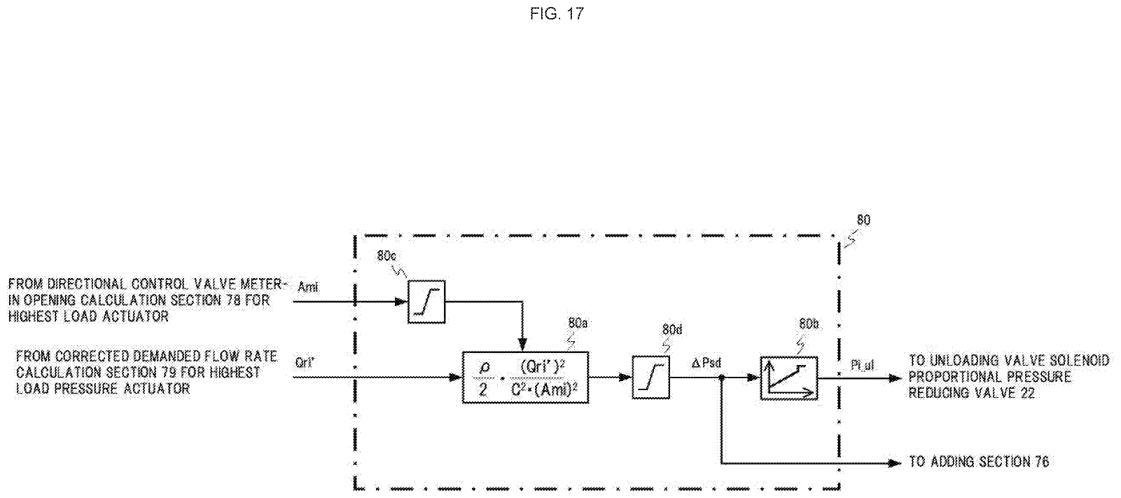

FIG. 17 depicts a functional block diagram of the target differential pressure calculation section 80.

In the calculation section 80, a corrected demanded flow rate Qri′ inputted from the corrected demanded flow rate calculation section 79 of the highest load pressure actuator is sent to a calculating section 80a, and a meter-in opening area Ami inputted from the directional control valve meter-in opening calculation section 78 of the highest load pressure actuator is sent to the calculating section 80a through a limiting section 80c. The calculating section 80a calculates a meter-in pressure loss of the directional control valve of the highest load pressure actuator, namely, the adjustment pressure for variably controlling the set pressure of the unloading valve 15, in accordance with the expression given below. The target differential pressure ΔPsd having passed a limiting section 80d is outputted to a table 80b and the external adding section 81. Here, C is a contraction coefficient determined in advance, and ρ is a density of the hydraulic fluid.

$$Δ Psd = \frac{ρ}{2} \cdot \frac{{( {Qri}^{′} )}^{2}}{{C}^{2} \cdot {( Ami )}^{2}} \qquad [ Math . 4 ]$$

In the table 80b, the target differential pressure ΔPsd is converted into a command pressure Pi_ul to the solenoid proportional pressure reducing valve 22 and outputs the command pressure Pi_ul as a command value.

˜Action˜

While, in the first embodiment, meter-in pressure losses ΔPsd1, ΔPsd2 and ΔPsd3 of the directional control valves 6a, 6b and 6c associated with the boom cylinder 3a, arm cylinder 3b and swing motor 3c are calculated, respectively, and a maximum among them is calculated as the overall target differential pressure ΔPsd, in the target differential pressure calculation section 80 in the second embodiment, the highest load pressure actuator decision section 77 decides the highest load pressure actuator and the target differential pressure calculation section 80 calculates the meter-in pressure loss of the highest load pressure actuator as the overall target differential pressure ΔPsd.

The unloading valve 15 is controlled to a set pressure that depends upon the target differential pressure ΔPsd, the highest load pressure Plmax and the spring force similarly as in the first embodiment. Further, the adding section 81 adds the target differential pressure ΔPsd to the highest load pressure Plmax that is an output of the maximum value selecting section 76 to calculate a target pump pressure Psd and outputs the target pump pressure Psd to the differencing section 82.

˜Advantage˜

1. Also in the present embodiment, advantages same as the advantages 1, 3, 4 and 5 of the first embodiment are achieved, and the following advantage similar to the advantage 2 is achieved.

2. In the present embodiment, the controller 90 calculates the meter-in opening areas of the plurality of directional control valves 6a, 6b and 6c on the basis of input amounts of the operation levers, calculates, on the basis of the opening area of a directional control valve (namely, specific directional control value) associated with the highest load pressure actuator in the plurality of directional control valves 6a, 6b and 6c and the demanded flow rate for the directional control valve (namely, the specific directional control valve), the meter-in pressure loss of the directional control valve (namely, the specific directional control valve), and outputs the pressure loss as the target differential pressure ΔPsd to control the set pressure Plmax+ΔPsd+spring force of the unloading valve 15. Consequently, since the set pressure of the unloading valve 15 is controlled to a value of the sum of the highest load pressure and the target differential pressure ΔPsd therefor, in such a case that, by a half operation of the directional control valve or specific directional control valve associated with the highest load pressure actuator or a like operation, the meter-in opening of the directional control valve is throttled, the set pressure of the unloading valve 15 is controlled carefully. As a result, for example, even in the case where the demanded flow rate changes suddenly at the time of transition from a combined operation including a half operation of the directional control valve associated with the highest load pressure actuator or the like to a half single operation or in a like case and the pump pressure increases suddenly due to insufficient responsiveness of pump flow rate control, bleed-off loss in which hydraulic fluid is discharged uselessly from the unloading valve 15 to the tank can be suppressed to the minimum and besides a sudden change of the actuator speed by a sudden change of the flow rate of the hydraulic fluid supplied to each actuator can be suppressed thereby implement superior combined operability.

### Third Embodiment

A hydraulic drive system for a construction machine according to a third embodiment of the present invention is described below focusing on differences from the first embodiment.

˜Structure˜

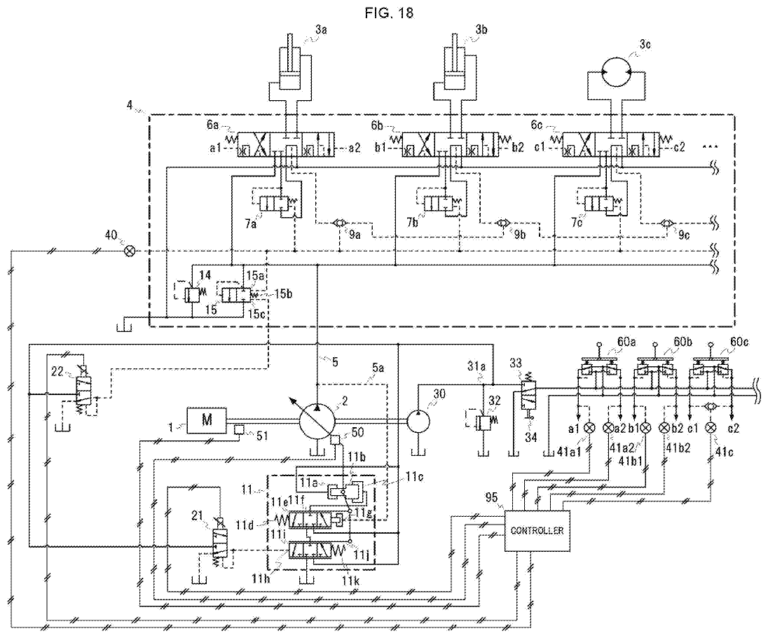

FIG. 18 is a view depicting a structure of the hydraulic drive system for a structure machine according to the third embodiment.

Referring to FIG. 18, the third embodiment is configured such that, in the first embodiment, the pressure sensor 42 for detecting the pressure of the hydraulic fluid supply line 5, namely, the pump pressure, is removed and a controller 95 is provided in place of the controller 70.

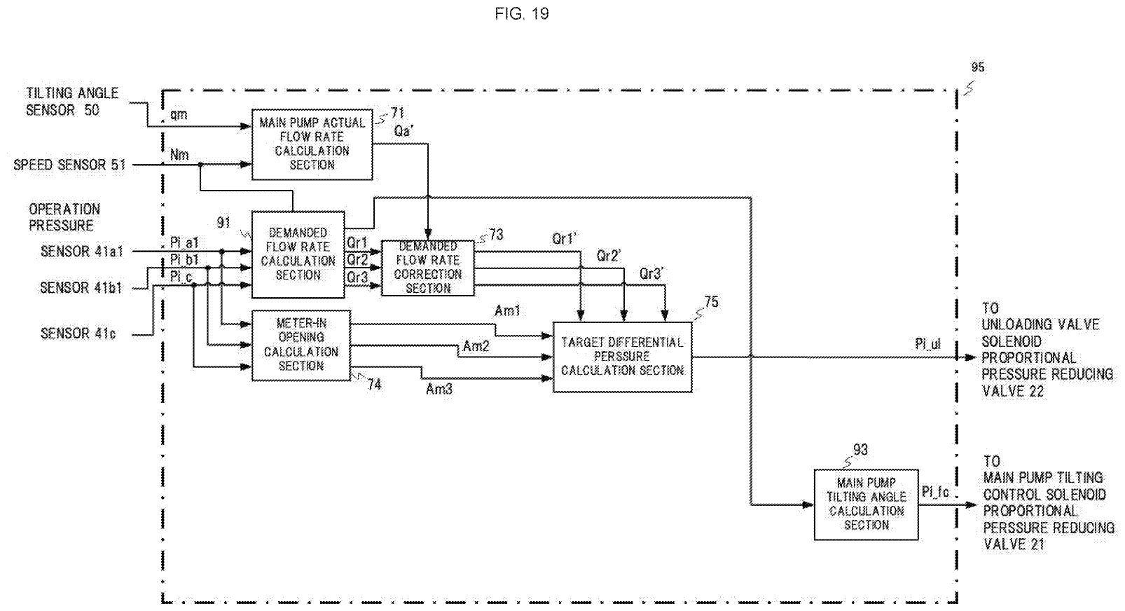

FIG. 19 depicts a functional block diagram of the controller 95 in the present embodiment.

Referring to FIG. 19, the different structure from the first embodiment depicted in FIG. 5 is that a demanded flow rate calculation section 91 and a main pump target tilting angle calculation section 93 are provided in place of the demanded flow rate calculation section 72 and the main pump target tilting angle calculation section 83 and the adding section 81 and the differencing section 82 are removed.

In the demanded flow rate calculation section 91 and the main pump target tilting angle calculation section 93, the controller 95 calculate the sum of the demanded flow rates of the plurality of actuators 3a, 3b and 3c on the basis of input amounts of the operation levers of the plurality of operation lever devices 60a, 60b and 60c, calculate a command value Pi_fc for making the delivery flow rate of the main pump 2 (namely, a hydraulic pump) equal to the sum the demanded flow rates, and outputs the command value Pi_fc to the regulator 11 (namely, a pump regulation device) to control the delivery flow rate of the main pump 2.

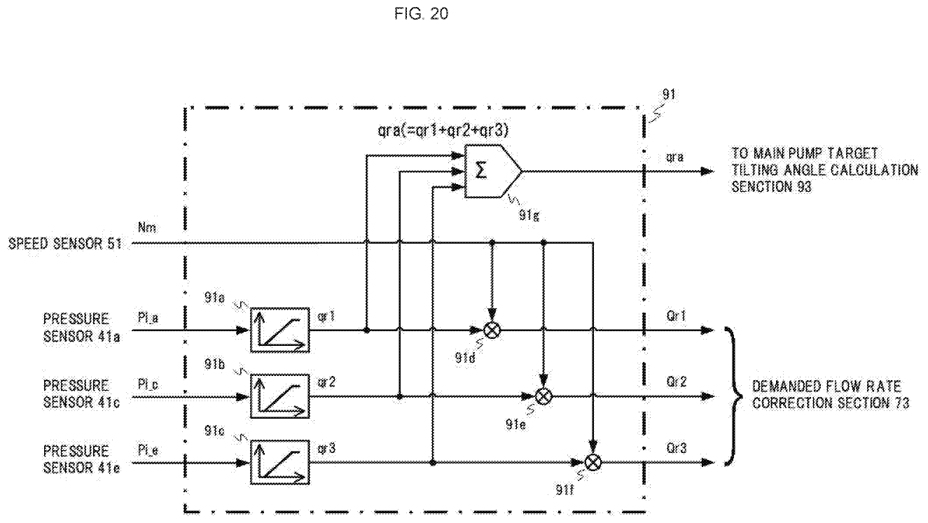

FIG. 20 depicts a functional block diagram of the demanded flow rate calculation section 91.

Referring to FIG. 20, operation pressures Pi_a1, Pi_b1 and Pi_c inputted from the pressure sensors 41a1, 41b1 and 41c are converted into demanded tilting angles or displacements qr1, qr2 and qr3 by tables 91a, 91b and 91c, and the demanded tilting angles qr1, qr2 and qr3 and an input Nm from the speed sensor 51 are multiplied by multipliers 91d, 91e and 91f to calculate demanded flow rates Qr1, Qr2 and Qr3, respectively. Further, a summing section 91g calculates qra=qr1+qr2+qr3 and outputs the sum qra of the demanded tilting angles to the main pump target tilting angle calculation section 93.

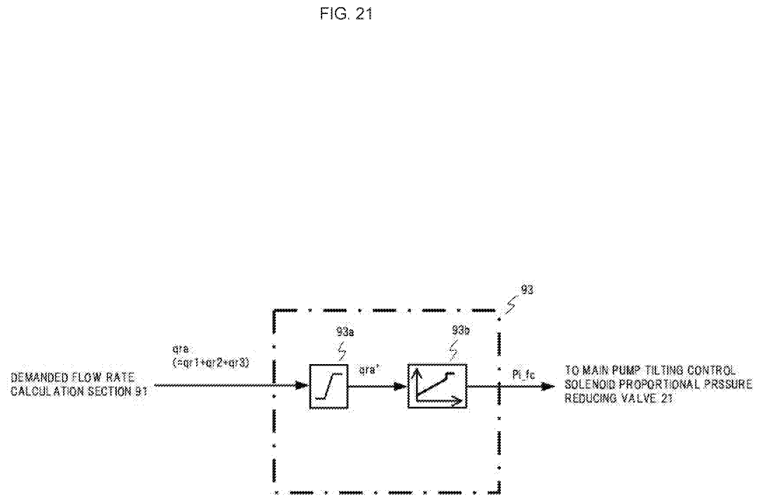

FIG. 21 depicts a functional block diagram of the main pump target tilting angle calculation section 93.

The input qra=qr1+qr2+qr3 from the demanded flow rate calculation section 91 is limited to a value between a minimum value and a maximum value of the tilting of the main pump 2 by a limiting section 93a and is converted into a command pressure Pi_fc to the solenoid proportional pressure reducing valve 21 by a table 93b and then outputted as a command value.

˜Action˜

While, in the first embodiment, so-called load sensing control of controlling the delivery flow rate of the main pump 2 such that the pressure of the hydraulic fluid supply line 5, namely, the pump pressure, becomes the highest load pressure Plmax+meter-in pressure loss of the highest load pressure actuator is performed, in the second embodiment, the main pump target tilting angle calculation section 93 determines the delivery flow rate of the main pump 2 only with the demanded tilting angle qra that depends only upon input amounts of the operation levers.

˜Advantage˜

1. Also in the present embodiment, advantages same as the advantages 1 to 3 and 6 of the first embodiment are achieved, and also the following advantage is achieved.

2. In the present embodiment, since the main pump 2 performs flow rate control in which the sum of demanded flow rates of the plurality of directional control valves 6a, 6b and 6c is calculated on the basis of input amounts of the operation levers to determine a target flow rate, a more stable hydraulic system can be implemented in comparison with the case in which load sensing control that is a kind of feedback control demonstrated by the first embodiment is performed. Further, the pressure sensors for detecting a pump pressure can be omitted, and the cost of the hydraulic system can be reduced further.

### <Others>

It is to be noted that, although, in the embodiments described above, the spring 15b is provided in order to stabilize action of the unloading valve 15, the spring 15b may not be provided. Further, without providing the spring 15b in the unloading valve 15, the value of “ΔPsd+spring force” may be calculated as a target differential pressure in the controller 70, 90 or 95.

In the second embodiment, a pump regulation device that performs load sensing control may be used similarly as in the first embodiment, and in the first embodiment, a pump regulation device that calculates the sum of demanded flow rates of the plurality of directional control valves 6a, 6b and 6c to perform flow rate control may be used similarly as in the second embodiment.

Furthermore, although the embodiments described hereinabove are directed to the case in which the construction machine is a hydraulic excavator having a crawler belt on the lower track structure, the construction machine may otherwise be a different construction machine such as, for example, a wheel type hydraulic excavator or a hydraulic crane. Also in this case, similar advantages are achieved.

### DESCRIPTION OF REFERENCE CHARACTERS

1: Prime mover
2: Variable displacement main pump (hydraulic pump)
3a to 3h: Actuator
4: Control valve block
5: Hydraulic fluid supply line (main)
6a to 6c: Directional control valve (control valve device)
7a to 7c: Pressure compensating valve (control valve device)
9a to 9c: Shuttle valve (highest load pressure detection
device)
11: Regulator (pump regulation device)
14: Relief valve
15: Unloading valve
15a, 15c: Pressure receiving portion
15b: Spring
21, 22: Solenoid proportional pressure reducing valve
30: Pilot pump
31a: Hydraulic fluid supply line (pilot)
32: Pilot relief valve
40, 41a1 to 41h2, 42: Pressure sensor
40a to 40c: Pressure sensor
60a to 60c: Operation lever device
70, 90, 95: Controller

1. A hydraulic drive system for a construction machine, comprising:
a variable displacement hydraulic pump;
a plurality of actuators driven by hydraulic fluid delivered from the hydraulic pump;
a control valve device that distributes and supplies the hydraulic fluid delivered from the hydraulic pump to the plurality of actuators;
a plurality of operation lever devices that instruct driving directions and speeds of the plurality of actuators;
a pump regulation device that controls a delivery flow rate of the hydraulic pump so as to deliver a flow rate according to input amounts of operation levers of the plurality of operation lever devices;
an unloading valve that discharges the hydraulic fluid of a hydraulic fluid supply line of the hydraulic pump to a tank when a pressure of the hydraulic fluid supply line increases and exceeds a set pressure equal to a sum of a highest load pressure of the plurality of actuators and at least a target differential pressure; and
a controller that controls the control valve device, wherein
the control valve device includes:
a plurality of directional control valves that are individually shifted by the plurality of operation lever devices and associated with the plurality of actuators to adjust driving directions and speeds of the respective actuators, and
a plurality of pressure compensating valves arranged in downstream sides of the plurality of directional control valves for controlling pressures in downstream sides of meter-in openings of the plurality of directional control valves such that the pressures in the downstream sides of the meter-in openings of the plurality of directional control valves becomes equal to the highest load pressure, and
the controller is configured to:
calculate demanded flow rates for the plurality of actuators and meter-in opening areas of the plurality of directional control valves based on input amounts of the operation levers of the plurality of operation lever devices, calculate a meter-in pressure loss of a particular directional control valve among the plurality of directional control valves based on the meter-in opening areas and the demanded flow rates, and output the pressure loss as the target differential pressure to control the set pressure of the unloading valve.

2. The hydraulic drive system for a construction machine according to claim 1, wherein
the controller is configured to select, as the meter-in pressure loss of the particular directional control valve, a maximum value of the meter-in pressure losses of the plurality of directional control valves and output the pressure loss as the target differential pressure to control the set pressure of the unloading valve.

3. The hydraulic drive system for a construction machine according to claim 1, further comprising:
a highest load pressure detection device that detects the highest load pressure of the plurality of actuators, wherein
the controller is configured to calculate, as the meter-in pressure loss of the particular directional control valve, a meter-in pressure loss of a directional control valve corresponding to the actuator of the highest load pressure detected by the highest load pressure detection device among the plurality of directional control valves and output the pressure loss as the target differential pressure to control the set pressure of the unloading valve.

4. The hydraulic drive system for a construction machine according to claim 1, further comprising:
a highest load pressure detection device that detects the highest load pressure of the plurality of actuators; and
a pressure sensor that detects a delivery pressure of the hydraulic pump, wherein
the controller is configured to calculate a command value for making the delivery pressure of the hydraulic pump detected by the pressure sensor equal to a sum of the highest load pressure detected by the highest load pressure detection device and the target differential pressure and output the command value to the pump regulation device to control the delivery flow rate of the hydraulic pump.

5. The hydraulic drive system for a construction machine according to claim 1, wherein
the controller is configured to calculate a sum of the demanded flow rates of the plurality of actuators based on the input amounts of the operation levers of the plurality of operation lever devices, calculate a command value for making the delivery flow rate of the hydraulic pump equal to the sum of the demanded flow rates and output the command value to the pump regulation device to control the delivery flow rate of the hydraulic pump.
